(19) United States
(12) Patent Application Publication
(10) Pub. No.: US 2021/0356587 A1
(43) Pub. Date: Nov. 18, 2021

(54) DISTANCE MEASUREMENT APPARATUS, DISTANCE MEASUREMENT METHOD, AND STORAGE MEDIUM

(71) Applicant: Panasonic Intellectual Property Management Co., Ltd., Osaka (JP)

(72) Inventors: YUMIKO KATO, Osaka (JP); KAZUKI NAKAMURA, Osaka (JP)

(21) Appl. No.: 17/388,315

(22) Filed: Jul. 29, 2021

Related U.S. Application Data
(63) Continuation of application No. PCT/JP2019/044259, filed on Nov. 12, 2019.

(30) Foreign Application Priority Data
Feb. 28, 2019 (JP) 2019-035656
Oct. 21, 2019 (JP) 2019-191666

(51) Int. Cl. G01S 17/08; G01S 7/481; G01S 17/89; G01S 7/486; G01S 7/4865; G01S 7/4861

(52) U.S. Cl. CPC G01S 17/08; G01S 7/4816; G01S 7/4815; G01S 7/4861; G01S 7/4868; G01S 7/4865; G01S 17/89

(57) ABSTRACT

A distance measurement apparatus includes at least one light source that emits a light beam towards a scene, a light receiving device that includes a plurality of light receiving elements and receives reflected light of the light beam from a scene, a control circuit, and a signal processing circuit. The control circuit performs control such that at least one exposure operation, in which at least part of the plurality of light receiving elements receive the reflected light, detect a charge generated by the reflected light, and accumulate the generated charge, and an operation of outputting the accumulated charge are executed repeatedly, and the at least one light source emits a plurality of light beams toward the scene between consecutive two charge output operations such that light irradiation regions do not overlap. The signal processing circuit generates and outputs distance data based on light reception data generated based on the charge.

### BACKGROUND

### 1. Technical Field

The present disclosure relates to a distance measurement apparatus, a distance measurement method, and a storage medium.

### 2. Description of the Related Art

Various devices have been proposed for measuring a distance to an object existing in space. For example, a system for measuring a distance to an object using a ToF (Time of Flight) technique is disclosed, for example, in Japanese Unexamined Patent Application Publication No. 2016-224062, Japanese Unexamined Patent Application Publication No. 2018-124271, Japanese Unexamined Patent Application Publication No. 2013-156138, etc.

In the ToF system disclosed in Japanese Unexamined Patent Application Publication No. 2016-224062, light modulated with a plurality of frequencies is used to eliminate aliasing of a ToF signal.

In the system disclosed in Japanese Unexamined Patent Application Publication No. 2018-124271, the space is scanned with a light beam, and reflected light from an object is detected thereby measuring a distance to the object. In this system, in each of a plurality of frame periods, a light beam is emitted while changing its direction, and reflected light is received sequentially by one or more light receiving elements of an image sensor. The operation performed in the above-described manner makes it possible to achieve a reduction in time required to acquire distance information on a whole target scene.

Japanese Unexamined Patent Application Publication No. 2013-156138 discloses a scanning method in which a scene is divided into a plurality of regions, and the regions are scanned with light with a spatial density which varies depending on the regions.

### SUMMARY

One non-limiting and exemplary embodiment provides a technique of acquiring distance information about a target scene in a more efficient manner.

In one general aspect, the techniques disclosed here feature a distance measurement apparatus including at least one light source that emits a light beam, a light receiving device that includes a plurality of light receiving elements and receives reflected light from the scene generated by irradiation of the light beam, a control circuit that performs a control operation on the at least one light source and the light receiving device, and a signal processing circuit. The control circuit causes at least one exposure operation and a charge output operation to be repeatedly executed such that in the at least one exposure operation, at least part of the plurality of light receiving elements detect a charge generated by received reflected light, and accumulate the generated charge while in the charge output operation, the accumulated charge is read out, and also causes the at least one light source to emit a plurality of light beams toward the scene between consecutive two charge output operations such that light irradiation regions do not overlap. The signal processing circuit generates distance data based on light reception data generated based on the charge, and outputs the resultant distance data.

According to one embodiment, it is possible to acquire distance information about a target scene in a more efficient manner.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram schematically illustrating a distance measurement apparatus according to an illustrative embodiment of the present disclosure;

FIG. 2 is a diagram schematically illustrating an example of a manner in which a distance measurement apparatus is used;

FIG. 3 is a block diagram illustrating an outline of a configuration of a distance measurement apparatus according to a first embodiment;

FIG. 4 is a diagram showing an example of light beam information stored in a memory;

FIG. 5 is a diagram schematically showing an area covered by a plurality of light beams defined by light beam information shown in FIG. 4;

FIG. 6A is a diagram illustrating an example of an operation of an indirect ToF method;

FIG. 6B is a diagram illustrating another example of an operation of an indirect ToF method;

FIG. 7A is a diagram illustrating a first example of a light detection method;

FIG. 7B is a diagram illustrating a second example of a light detection method;

FIG. 8 is a perspective view schematically illustrating an example of a light emitting device;

FIG. 9 is a diagram schematically illustrating a cross-sectional structure of an optical waveguide element and an example of propagating light;

FIG. 10A is a diagram illustrating a cross-section of an optical waveguide array that emits light in a direction perpendicular to an exit face of the optical waveguide array;

FIG. 10B is a diagram illustrating a cross-section of an optical waveguide array that emits light in a direction which is not perpendicular to an exit face of the optical waveguide array;

FIG. 11 is a perspective view schematically illustrating an optical waveguide array in a three-dimensional space;

FIG. 12 is a schematic diagram of an optical waveguide array and a phase shifter array as viewed from a normal direction (a Z direction) of a light exit face;

FIG. 13 is a diagram illustrating an example of a light source;

FIG. 14 is a diagram illustrating another example of a configuration of a light source;

FIG. 15 is a diagram illustrating still another example of a configuration of a light source;

FIG. 16 is a diagram illustrating still another example of a configuration of a light source;

FIG. 17A is a side view schematically illustrating an example of a configuration of a light receiving device;

FIG. 17B is a perspective view schematically illustrating an example of a configuration of a light receiving device;

FIG. 18 is a diagram illustrating an example of data stored in a memory;

FIG. 19 is a flowchart illustrating an outline of an operation of a distance measurement apparatus according to a first embodiment;

FIG. 20A is a diagram schematically illustrating a relationship among a direction of an emitted light beam, a position of an object, and a position of a light reception;

FIG. 20B is a diagram illustrating an example of an efficient scanning method;

FIG. 21A is a flowchart illustrating an example of a detailed operation in step S1200;

FIG. 21B is a flowchart illustrating another example of a detailed operation in step S1200;

FIG. 21C is a flowchart illustrating still another example of a detailed operation in step S1200;

FIG. 22 is a flowchart illustrating an example of a detailed operation in step S1300;

FIG. 23 is a flowchart illustrating an example of a detailed operation in step S1400;

FIG. 24 is a diagram illustrating an example of data stored in a memory according to a modification;

FIG. 25 is a diagram illustrating an operation according to a modification;

FIG. 26 is a block diagram illustrating a basic configuration of a distance measurement apparatus according to a second embodiment;

FIG. 27A is a diagram schematically illustrating an example of an arrangement of two light sources in according to the second embodiment;

FIG. 27B is a diagram schematically illustrating an example of an arrangement of four light sources;

FIG. 28 is a block diagram illustrating an example of a configuration of a distance measurement apparatus according to the second embodiment;

FIG. 29 is a diagram illustrating an example of information stored in a memory according to the second embodiment;

FIG. 30 is a diagram illustrating a coordinate system in an image sensor plane;

FIG. 31A is a flowchart illustrating an example of an operation in step S1200 according to the second embodiment;

FIG. 31B is a flowchart illustrating another example of an operation in step S1200 according to the second embodiment;

FIG. 31C is a flowchart illustrating still another example of an operation in step S1200 according to the second embodiment;

FIG. 31D is a flowchart illustrating in detail an operation of selecting directions of a plurality of light beams for respective light sources in step S3260;

FIG. 32A is a diagram illustrating a first example of an operation according to the second embodiment;

FIG. 32B is a diagram illustrating a second example of an operation according to the second embodiment;

FIG. 33 is a flowchart illustrating a light emission operation and an exposure operation according to the second embodiment;

FIG. 34A is a diagram illustrating an example of an operation according to a modification of the second embodiment; and

FIG. 34B is a diagram illustrating an example of an operation according to another modification of the second embodiment.

### DETAILED DESCRIPTION

Before describing embodiments of the present disclosure, underlying knowledge forming basis of the present disclosure is described.

There is known a ToF system for measuring a distance to an object based on a difference between the timing of emitting light toward an object and the timing of receiving reflected light while changing the direction of light emission. In such a system, it takes a long time to scan an entire target scene. As a technique for reducing the time required to scan the entire scene, for example, a technique is disclosed in Japanese Unexamined Patent Application Publication No. 2018-124271. In this system, in each of a plurality of frame periods, reflected light is detected by a plurality of light receiving elements of an image sensor while changing the direction of a light beam. The distance is measured by performing a calculation based on signals output from the respective light receiving elements. By performing such an operation, it is possible to reduce the time required to acquire the distance information associated with the entire target scene.

The present inventors have found that in a system in which in one frame period, a light beam is emitted in a plurality of directions and reflected light is detected, there is a possibility that a plurality of pieces of reflected light from a plurality of different objects are incident on the same light receiving element. In a case where the axis of the light beam emitted from the light source and the axis of the light beam received by the image sensor are coincident, the distance to an object located on the axis of those light beams can be measured correctly. On the other hand, in a case where an optical component such as a lens is placed in front of the image sensor, light diffused from a specific direction as viewed from the center point of the light receiving surface of the image sensor is focused on one point on the light receiving surface via the optical component. At the time when the light beam is emitted from the light source, the position of the object that reflects the light beam is unknown. That is, the direction of the reflected light as seen from the center point of the light receiving surface of the image sensor is unknown, and it is unknown which light receiving element receives the reflected light. Therefore, if a plurality of light beams are consecutively emitted in different directions in a preset frame period, there is a possibility that a plurality of pieces of reflected light from a plurality of different objects are incident on the same light receiving element. In this case, the distance at a position corresponding to this light receiving element cannot be accurately measured.

The present inventors have conceived a method for solving the above-described problem by appropriately determining a combination of directions of a plurality of light beams based on a relationship between the direction of the light beam and the direction of the reflected light. By appropriately determining the combination of the directions of the plurality of light beams, it becomes possible to prevent a plurality of pieces of reflected light from reaching the same point on the light receiving surface of the light receiving device regardless of the positions of the objects. By emitting light beams in a plurality of different directions which are determined in the above-described manner in a preset unit period, it is possible to obtain more accurate distance information.

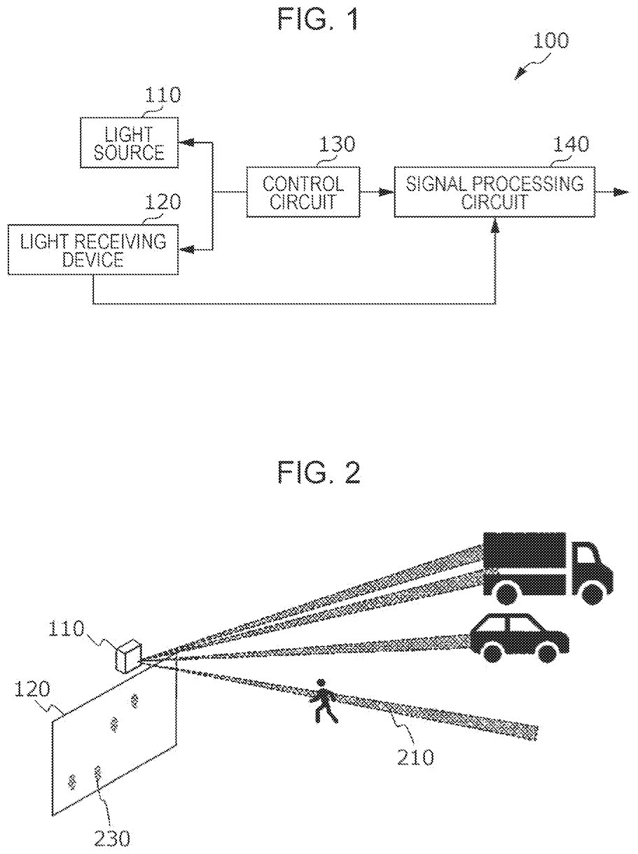

An outline of an embodiment of the present disclosure is described below with reference to FIG. 1.

FIG. 1 is a diagram schematically illustrating a distance measurement apparatus 100 according to an illustrative embodiment of the present disclosure. This distance measurement apparatus 100 includes at least one light source 110 capable of changing an emission direction of a light beam, a light receiving device 120, a control circuit 130, and a signal processing circuit 140. In this example, the control circuit 130 and the signal processing circuit 140 are respectively realized by two separate circuits. However, the control circuit 130 and the signal processing circuit 140 may be realized together by a single circuit. Each of the control circuit 130 and the signal processing circuit 140 may be realized by a set of plurality of circuits.

The light source 110 is a light emitting device capable of emitting a light beam in a plurality of different directions. The light source 110 scans a scene by changing the emission direction of the light beam emitted toward the scene. The light receiving device 120 includes a plurality of light receiving elements, and each light receiving element has a function of detecting light. The light receiving device 120 may include, for example, an image sensor including a plurality of light receiving elements which are two-dimensionally arranged along an image sensing plane, and an optical system that forms an image on the image sensing plane of the image sensor. The light receiving device 120 receives light reflected from the scene generated by the irradiation of the light beam. The control circuit 130 controls the light source 110 and the light receiving device 120. The control circuit 130 performs control such that operations described below are executed: (a) at least one exposure operation and a charge output operation are executed repeatedly such that in the at least one exposure operation, at least part of the plurality of light receiving elements detect a charge generated by received reflected light and accumulate the generated charge while in the charge output operation, the accumulated charge is read out, and (b) at least one light source 110 emits a plurality of light beams toward a scene between consecutive two charge output operations such that light irradiation regions do not overlap.

The plurality of light receiving elements generate light reception data based on accumulated charges. The signal processing circuit 140 generates and outputs distance data based on the light reception data output from the plurality of light receiving elements. In the present disclosure, the “distance data” refers to data in any form representing an absolute distance to one or more measurement points in a scene from a reference point or a relative distance between measurement points. The distance data may be, for example, distance image data, which is two-dimensional image data in which distance information of a measurement point corresponding to each pixel is attached to the pixel. The distance data may be three-dimensional point group data representing three-dimensional coordinates of respective measurement points. The distance data is not limited to data that directly represents distances, but the distance data may be sensor data itself, that is, raw data acquired in the distance measurement. The raw data is, for example, light reception data indicating an amount of light detected by each light receiving element of the light receiving device 120. The raw data can be treated as distance data together with additional data required to calculate the distance. Associated data is, for example, data indicating an exposure timing and an exposure time width of each light receiving element, which are used in a distance calculation by indirect ToF described later.

At least one light source 110 may be a single light source or a plurality of light sources. The light source 110 may be configured to emit light beams in a plurality of directions at the same time, or may be configured to change the direction of a light beam in a unit period. That is, the plurality of light beams may be emitted at the same time or may be emitted sequentially. The control circuit 130 controls the exposure timing of each of the plurality of light receiving element such that the reflected light of each of the plurality of light beams is received by one of the plurality of light receiving elements. The at least one light source 110 scans the scene by repeatedly emitting a plurality of light beams while changing the combination of directions.

In an embodiment, the control circuit 130 determines the directions of the plurality of light beams such that the reflected light beams originating from the plurality of light beams are respectively incident on different ones of the plurality of light receiving elements. For example, in a case where the plurality of light receiving elements are two-dimensionally arranged along a light receiving surface of the light receiving device 120, the control circuit 130 may determine a combination of directions of the plurality of light beams such that paths of the plurality of light beams projected onto the light receiving surface do not overlap and do not intersect with each other on the light receiving surface. By making the determination in the above-described manner, it is possible to prevent a plurality of pieces of reflected light from a plurality of objects from being incident on one light receiving element.

The control circuit 130 may start and stop the exposure operation for all the light receiving elements at a particular exposure start timing and at a particular exposure stop timing. Even in this case, only part of the light receiving elements receive the reflected light originating from the plurality of light beams emitted from the light source 110. Therefore, in one exposure period, only light reception data from part of all light receiving elements is used in the distance measurement.

The “light reception data” may be, for example, a signal indicating the amount of light detected by a light receiving element. Such light reception data may be used, for example, in performing distance measurement by the indirect ToF method which will be described later. When the distance measurement is performed by the indirect ToF method, a plurality of exposure periods may be set in a unit period for the respective light receiving element. The distance can be obtained by performing a calculation using the light reception data obtained in the plurality of exposure periods. The “light reception data” may be a signal indicating the fact that a light receiving element has detected light, or a signal indicating a time from emitting a light beam until corresponding light is detected. Such light reception data may be used, for example, in performing distance measurement by the direct ToF method described later.

In an embodiment, the control circuit 130 performs control such that in each of the plurality of unit periods each including at least one charge output operation, the at least one light source 110 emits a plurality of light beams, and at least part of the plurality of light receiving elements receive reflected light from a scene originating from the plurality of light beams. In this operation, the combination of the directions of the plurality of light beams may be set differently from one unit period to another. For example, the entire plurality of light beams emitted in the plurality of unit periods may be determined so as to cover the entire area of interest in a preset distance range. The generation of the distance information may be performed based on light reception data obtained at part of the light receiving elements in each unit period. The signal processing circuit 140 may generate distance data at positions of part of light receiving elements that have received reflected light in each unit period. Alternatively, the signal processing circuit 140 may generate distance data for the entire distance measurement target area after the emission and reception of the plurality of light beams are completed for all the plurality of unit periods.

The above descriptions of “the combination of directions of the plurality of light beams is different” and “the plurality of light beams are repeatedly emitted while changing the combination of directions” mean that at least one of the emission directions of the plurality of light beams in a certain period is different from any of the emission directions of the plurality of light beams in another period. For example, each of the emission directions of the plurality of light beams in a certain period may be different from any of the emission directions of the plurality of light beams in another period. The number of light beams emitted in a certain period may be the same as or different from the number of light beams emitted in another period. The emission directions of the plurality of light beams in a certain period may be the same as the emission directions of the plurality of light beams in another period.

FIG. 2 is a diagram schematically illustrating an example of a manner in which the distance measurement apparatus 100 is used. In this example, the light receiving device 120 includes an image sensor for acquiring a two-dimensional image. The light source 110 emits a plurality of light beams 200 in each unit period. In the example shown in FIG. 2, four light beams 200 are shown by way of example. The number of light beams emitted in one unit period is not limited to four, and an arbitrary number equal to or larger than 2 may be employed. In FIG. 2, a person and a plurality of vehicles are shown as examples of distance measurement target objects. As shown in FIG. 2, the distance measurement apparatus 100 may be used to measure the distance to an object such as a person or a vehicle located on a road. The distance measurement apparatus 100 may be used, for example, as a component of an in-vehicle LiDAR (Light Detection and Ranging) system.

According to the above-described configuration, a plurality of light beams are emitted in each unit period, and distance information of a plurality of locations in a target scene can be acquired. Therefore, the distance can be measured for the entire scene in a short time as compared with the conventional distance measuring system that emits light in only one direction in each unit period. Furthermore, reflected light from a plurality of different objects is prevented from being incident on the same one light receiving element, and thus more accurate distance measurement can be achieved.

Specific embodiments of the present disclosure are described below with reference to the drawings. It should be noted that all of the embodiments described below show comprehensive or specific examples. Numerical values, shapes, components, positions of components, and a manner in which components are connected, steps, an order of steps, and the like shown in the following embodiments are merely examples, and are not intended to limit the present disclosure. Among components described in the following embodiments, those components that are not described in independent claims indicating highest-level concepts of the present disclosure are optional. Each figure provides a schematic view and is not necessarily exactly illustrated. In figures, substantially the same components are denoted by the same or similar reference numerals, and duplicate descriptions thereof may be omitted or simplified.

In the present disclosure, all or part of circuits, units, apparatuses, elements or portions, or all or part of functional blocks in block diagrams, may be executed, for example, by a single electronic circuit or a plurality of electronic circuits including a semiconductor device, a semiconductor integrated circuit (IC), or an LSI (large scale integration). The LSI or IC may be integrated on one chip, or may be configured by combining a plurality of chips. For example, functional blocks other than storage devices may be integrated on one chip. LSIs or ICs applicable to the embodiments may have different names depending on the degree of integration, such as system LSIs, VLSIs (very large scale integrations), or ULSIs (ultra large scale integrations). A Field Programmable Gate Array (FPGA), which is programmed after an LSI is manufactured, or a reconfigurable logic device that can be reconfigured in terms of internal connections in the LSI or can be set up in terms of circuit partitions in the LSI may also be used.

All or part of functions or operations of circuits, units, apparatuses, elements or portions may be executed by software processing. In this case, the software is stored in a non-transitory storage medium such as one or more ROMs, optical disks, hard disk drives, etc., and when the software is executed by a processing apparatus (a processor), a function identified by the software is executed on the processing apparatus (the processor) and/or a peripheral. The system or the apparatus may include one or more non-transitory storage media in which the software is stored, the processing apparatus (the processor), and a hardware device, such as an interface used in the processing.

### First Embodiment

A configuration and an operation of the distance measurement apparatus according to a first embodiment of the present disclosure are described below.

### 1-1 Configuration of Distance Measurement Apparatus

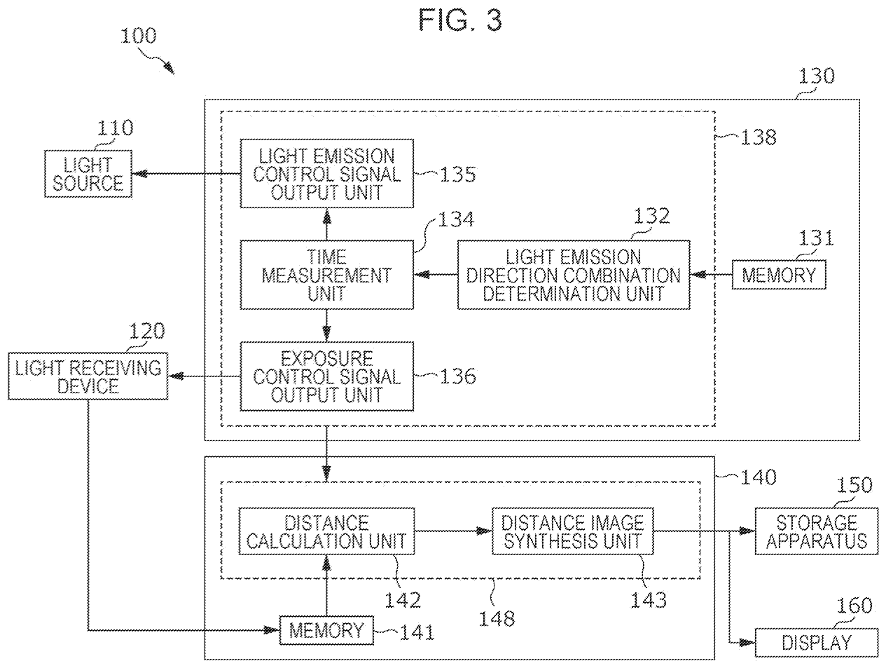

FIG. 3 is a block diagram illustrating an outline of a configuration of a distance measurement apparatus 100 according to a first embodiment. The distance measurement apparatus 100 includes a light source 110, a light receiving device 120, a control circuit 130, a signal processing circuit 140, a storage apparatus 150, and a display 160. The control circuit 130 includes a memory 131 and a processor 138. The signal processing circuit 140 includes a memory 141 and a processor 148.

The light source 110 is, for example, a light emitting device capable of emitting a plurality of light beams in different directions at the same time or sequentially at short time intervals. The light source 110 may be, for example, a laser light source. A reach distance of each light beam emitted from the light source 110 may be, for example, about 100 to 200 meters. The reach distance of the light beam is not limited to the above example, but may be set to an arbitrary value.

The light receiving device 120 includes an image sensor including a plurality of light receiving elements arranged two-dimensionally on an image sensing surface, and an optical system that forms an image on the image sensing surface of the image sensor. In the following description, the light receiving elements may also be referred to as “pixels”. The image sensor outputs light reception data according to the amount of light received by each light receiving element in the specified exposure period. Each light receiving element may include a photoelectric conversion element such as a photodiode and one or more charge accumulation units for accumulating a charge generated as a result of the photoelectric conversion. When each light receiving element receives light, it performs photoelectric conversion and outputs an electric signal according to the amount of received light.

In the present embodiment, the distance between the light source 110 and the light receiving device 120 may be, for example, about several millimeters. The distance range of the distance measurement may be, for example, from 0 to about 200 meters, and in many cases, the lower end of the distance range is about several meters. Considering this, it is possible to regard that the light source 110 and the light receiving device 120 are located substantially at the same point in a spatial coordinate system. Therefore, a light beam emitted from the light source 110 is reflected by an object located in a direction of the light beam and is received by the light receiving device 120 located at substantially the same position as the light source 110.

The control circuit 130 controls the operations of the light source 110, the light receiving device 120, and the signal processing circuit 140. The control circuit 130 determines the direction and timing of emission of each of the plurality of light beams by the light source 110 and the timing of the exposure operation by each light receiving element of the light receiving device 120. The determination of the emission directions of the plurality of light beams is made such that reflected light beams from a plurality of objects do not enter the same light receiving element in the same unit period. According to the determined timing, the control circuit 130 generates a light emission control signal for controlling the light source 110 and an exposure control signal for controlling the light receiving device 120 and applies them to the light source 110 and the light receiving device 120, respectively. In response to the applied light emission control signal, the light source 110 emits a plurality of light beams in different directions in response to the input light emission control signal. In response to the applied exposure control signal, the light receiving device 120 executes an exposure operation by each light receiving element.

The signal processing circuit 140 acquires the light reception data generated in each exposure period by the light receiving device 120, and calculates the distance to the object based on the light reception data. In the present embodiment, the distance is calculated by the indirect ToF method, for example, as will be described later. In each of the plurality of unit periods, the distances to objects located in a plurality of different directions are measured. By repeating this operation while changing the combination of the light beam emission directions, the distance information of the entire scene is acquired. The signal processing circuit 140 generates distance data for the entire scene when the light emission and the light reception in the plurality of unit periods are completed. The generated distance data is stored in the storage apparatus 150. The storage apparatus 150 may include any type of storage medium, such as a hard disk or a memory. An image based on the distance data may be displayed on the display 160. The distance data may be, for example, data of a distance image having a distance value for each pixel.

As described above, the distance measurement apparatus 100 repeatedly executes the emission of the plurality of light beams and the detection of the reflected light thereof in each of fixed unit periods while changing the combination of the emission directions of the plurality of light beams. By combining the distance data acquired in the respective unit periods, it is possible to generate a distance image of the entire scene.

Each component will be described in further detail below.

### 1-1-1 Configuration of Control Circuit 130

The control circuit 130 may be realized by an electronic circuit such as a microcontroller unit (MCU). The control circuit 130 shown in FIG. 3 includes a processor 138 and a memory 131. The processor 138 may be realized by, for example, a CPU (Central Processing Unit). The memory 131 may include, for example, a non-volatile memory such as a ROM (Read Only Memory) and a volatile memory such as a RAM (Random Access Memory). The memory 131 stores a computer program executed by the processor 138. The processor 138 can execute an operation described later by executing the program.

The processor 138 includes a light emission direction combination determination unit 132, a time measurement unit 134, a light emission control signal output unit 135, and an exposure control signal output unit 136. The memory 131 is a storage medium that stores a computer program executed by the processor 138, information defining a plurality of light beams emitted from the light source 110, and various kinds of data generated in a process. The functions of the light emission direction combination determination unit 132, the time measurement unit 134, the light emission control signal output unit 135, and the exposure control signal output unit 136 may be realized, for example, by executing the program stored in the memory 131 by the processor 138. In this case, the processor 138 functions as the light emission direction combination determination unit 132, the time measurement unit 134, the light emission control signal output unit 135, and the exposure control signal output unit 136. Each of these functional unit may be realized by dedicated hardware.

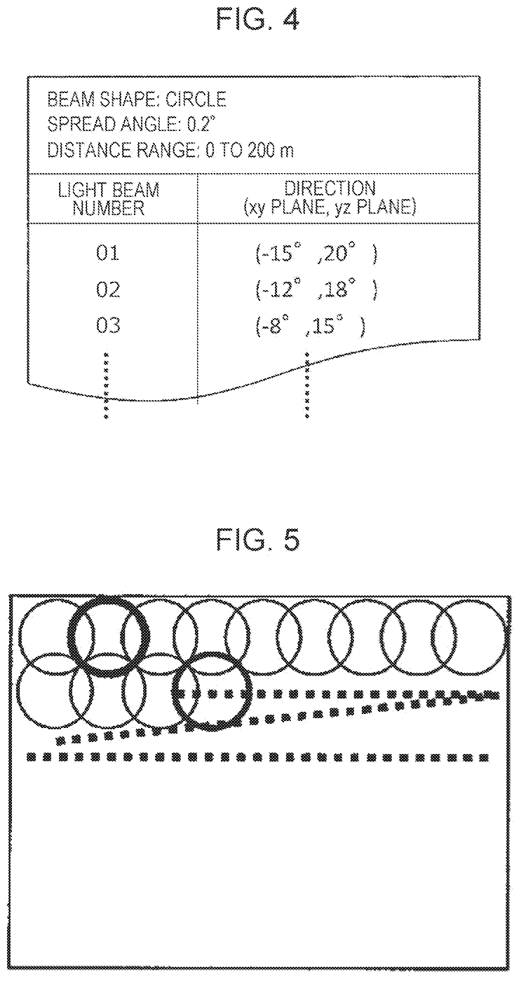

FIG. 4 is a diagram showing light beam information stored in the memory 131. In the example shown in FIG. 4, information on the shape of the beam, the spread angle of the beam, and the distance range is stored as information common to the plurality of light beams. Furthermore, for each light beam, information on the light beam number and information on the emission direction are stored. The distance range refers to the range of the distance measured using the light beam. In the example shown in FIG. 4, the distance range is 0 to 200 meters, but other different distance ranges may be set and used. In this example, an x-axis and a y-axis are set such that they are both parallel to the image sensing surface of the light receiving device 120 and orthogonal to each other, and a z-axis is set in a direction perpendicular to the image sensing surface and toward a scene. The emission direction of each light beam may be specified by an angle from the x-axis when projected onto the xy plane and an angle from the z-axis when projected onto the yz plane. The information shown in FIG. 4 is merely an example, and information different from the above may be stored in the memory 131. In the example shown in FIG. 4, the emission direction is described by the angles when projected onto the xy plane and the yz plane, respectively, but the emission direction may be described in other manners.

FIG. 5 is a diagram schematically showing a region covered by a plurality of light beams defined by the light beam information shown in FIG. 4. A plurality of circles in FIG. 5 show cross sections of the plurality of light beams where each cross section is taken in a plane parallel to the light receiving surface of the light receiving device 120 and away from the light source 110 by a predetermined distance (for example, 100 meters). By emitting all of the plurality of light beams defined by the light beam information at the same time as in this example, it is possible to comprehensively cover the entire scene. In the present embodiment, only part of these light beams are emitted in one unit period. The combination of light beams emitted is different for each one unit period. For reference, in FIG. 5, by way of example, two light beams emitted in a certain same unit period are represented by thick circles.

The light emission direction combination determination unit 132 shown in FIG. 3 determines the combination of a plurality of light beams to be emitted, the timing of emitting them, and an order of emitting the light beams in each unit period. In the present embodiment, a plurality of light beams are consecutively emitted in each unit period. The light emission direction combination determination unit 132 refers to the light beam information stored in the memory 131, and selects, from among the light beams that have not yet been emitted, a combination of a plurality of light beams that are to be consecutively emitted in each unit period.

The time measurement unit 134 is a unit for measuring time.

The light emission control signal output unit 135 outputs the light emission control signal that controls the light source 110. The light emission control signal is generated based on the light beam information (see FIG. 4) defining the direction, the beam shape, and the intensity of each light beam. The light source 110 emits a plurality of light beams sequential according to the light emission control signal.

The exposure control signal output unit 136 outputs an exposure control signal that controls the exposure operation by the image sensor in the light receiving device 120. The image sensor performs an exposure operation by each light receiving element according to the exposure control signal.

An example of a common distance measurement method by an indirect ToF method is described below. In the ToF method, the distance from a device to an object is measured by measuring the flight time from the emission of light from a light source until the light returns to a photodetector located close to the light source after the light is reflected by the object. When the flight time is measured directly, the method is called direct ToF. In a case where a plurality of exposure periods are provided and the flight time is calculated from the energy distribution of the reflected light over the plurality of exposure periods, the method is called indirect ToF

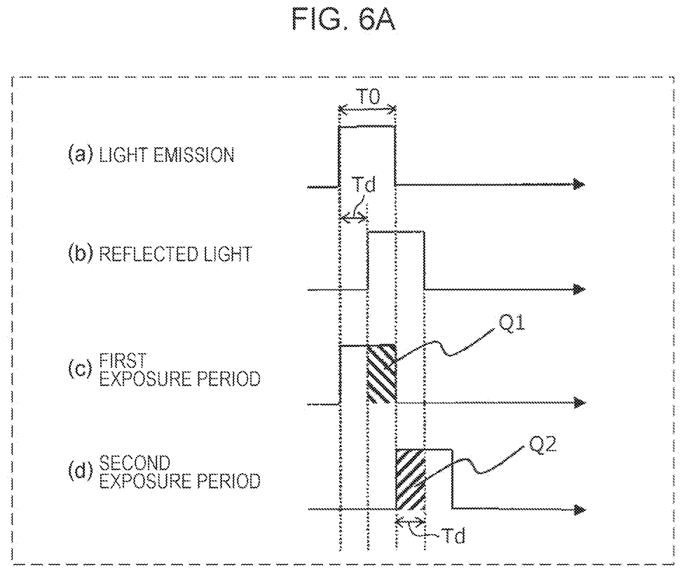

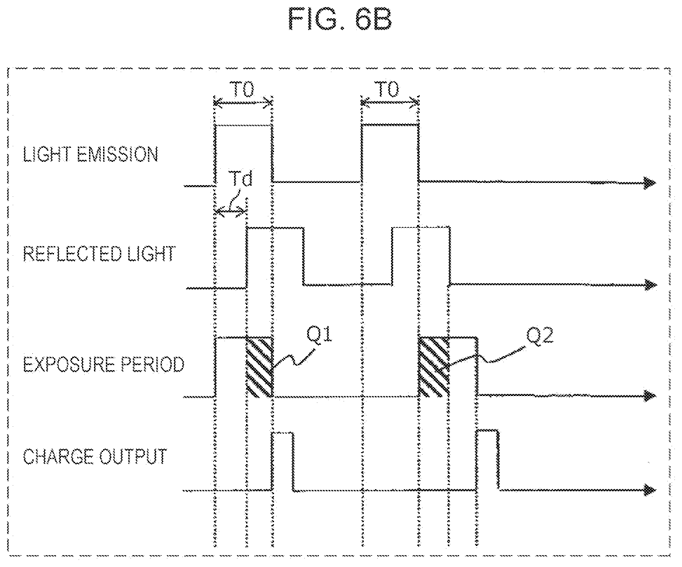

FIG. 6A is a diagram showing an example of a light emission timing, an arrival timing of reflected light, and two exposure timings in the indirect ToF method. The horizontal axis represents the time. Rectangles represent a light emission period, a reflected light reception period, and two exposure periods. In this example, for the sake of simplicity, an example is described for a case where one light beam is emitted and a light receiving element, which receives reflected light originating from the light beam, performs an exposure operation twice in succession. FIG. 6A(a) shows the timing at which light is emitted from the light source. To denotes a pulse width of a light beam for the distance measurement. FIG. 6A(b) shows a period in which reflected light generated when the light beam emitted from the light source is reflected by an object reaches an image sensor. Td denotes a flight time of the light beam. In the example shown in FIG. 6A, the reflected light reaches the image sensor in a period of time Td shorter than the time width T0 of the light pulse. FIG. 6A(c) shows a first exposure period of the image sensor. In this example, the exposure operation is started at the same time as the start of the light emission, and the exposure operation is ended at the same time as the end of the light emission. In the first exposure period, part of the reflected light that returns early is photoelectrically converted and a charge generated as a result of photoelectric conversion is accumulated. Q1 represents the energy of the light photoelectrically converted in the first exposure period. This energy Q1 is proportional to the amount of charge accumulated in the first exposure period. FIG. 6A(d) shows a second exposure period of the image sensor. In this example, the second exposure period starts at the same time as the end of the light emission, and ends when a time equal to pulse width T0 of the light beam, that is, the time with the length equal to the first exposure period elapses. Q2 represents the energy of the light photoelectrically converted in the second exposure period. This energy Q2 is proportional to the amount of charge accumulated in the second exposure period. In the second exposure period, part of the reflected light that arrives after the end of the first exposure period is received. Since the length of the first exposure period is equal to the pulse width T0 of the light beam, the time width of the reflected light received in the second exposure period is equal to the flight time Td.

Let Cfd1 denote the integrated capacity of the charge accumulated in a light receiving element in the first exposure period, Cfd2 denote the integrated capacity of the charge accumulated in a light receiving element in the second exposure period, Iph denote a photocurrent, and N denote the number of charge transfer clocks. The output voltage of the light receiving element in the first exposure period is given by Vout1 shown below.

Vout1=Q1/Cfd1=N×Iph×(T0−Td)/Cfd1

The output voltage of the light receiving element in the second exposure period is given by Vout2 shown below.

Vout2=Q2/Cfd2=N×Iph×Td/Cfd2

In the example shown in FIG. 6A, the time length of the first exposure period and the time length of the second exposure period are equal, and thus Cfd1=Cfd2. Therefore, Td can be expressed by an equation shown below.

Td={Vout2/(Vout1+Vout2)}×T0

Assuming that the speed of light is given by C (≈3×10⁸ m/s), the distance L between the device and the object is given by an equation shown below.

L=½×C×Td=½×C×{Vout2/(Vout1+Vout2)}×T0

The image sensor outputs the charge accumulated in the exposure period, and thus there is a possibility that the outputting of the charge makes it difficult to perform an exposure operation twice consecutively in time. In this case, for example, a method shown in FIG. 6B may be used.

FIG. 6B is a diagram schematically showing timings of light emission, exposure, and charge output when two exposure periods are not provided in succession. In the example shown in FIG. 6B, first, the image sensor starts exposure at the same time when the light source starts emitting light, and the image sensor ends the exposure operation at the same time when the light source ends the emission of light. This exposure period corresponds to the first exposure period in FIG. 6A. Immediately after the end of the exposure operation, the image sensor outputs the charge accumulated in this exposure period. The amount of output charge corresponds to the energy Q1 of the received light. Next, the light source starts the light emission again, and ends the light emission when the time T0 equal to that in the first-time exposure period elapses. The image sensor starts an exposure operation at the same time when the light source ends the emission of light, and ends the exposure operation when a time with time length equal to the first exposure period elapses. This exposure period corresponds to the second exposure period in FIG. 6A. Immediately after the end of the exposure operation, the image sensor outputs the charge accumulated in this exposure period. The amount of output charge corresponds to the energy Q2 of the received light.

As described above, in the example shown in FIG. 6B, in order to acquire signals for use in the distance calculation, the light source emits light twice, and the image sensor performs the exposure operation at different timings for each light emission. This makes it possible to acquire a voltage in each exposure period even in a case where two exposure periods are not provided consecutively in time. In the image sensor that outputs the charge in each exposure period in the manner described above, in order to obtain information on the charge accumulated in each of the plurality of preset exposure periods, light is emitted under the same condition as many times as the set number of exposure periods.

In actual distance measurements, there is a possibility that the image sensor receives not only reflected light that is generated when the light emitted from the light source is reflected by an object, but also background light, that is, light from an external circumstance such as sunlight or ambient lighting. Therefore, in general, an exposure period is provided for measuring a charge accumulated by a background light incident on the image sensor in a state where no light beam is emitted. By subtracting the amount of charge measured in the background exposure period from the amount of charge measured when the reflected light of the light beam is received, it is possible to determine the amount of charge due to only the reflected light of the light beam. In this embodiment, for the sake of simplicity, a description of an operation related to the background light is omitted.

In the above example, for the sake of simplicity, the description has been given as to only one light beam, but actually in the present embodiment, a plurality of light beams are consecutively emitted in each unit period. An example of a light detection operation is described below for a case where two light beams are consecutively emitted.

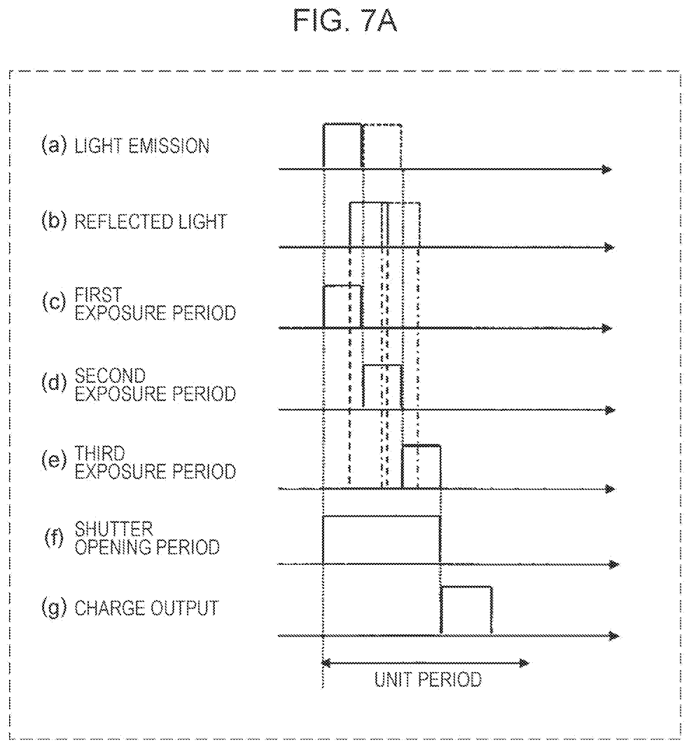

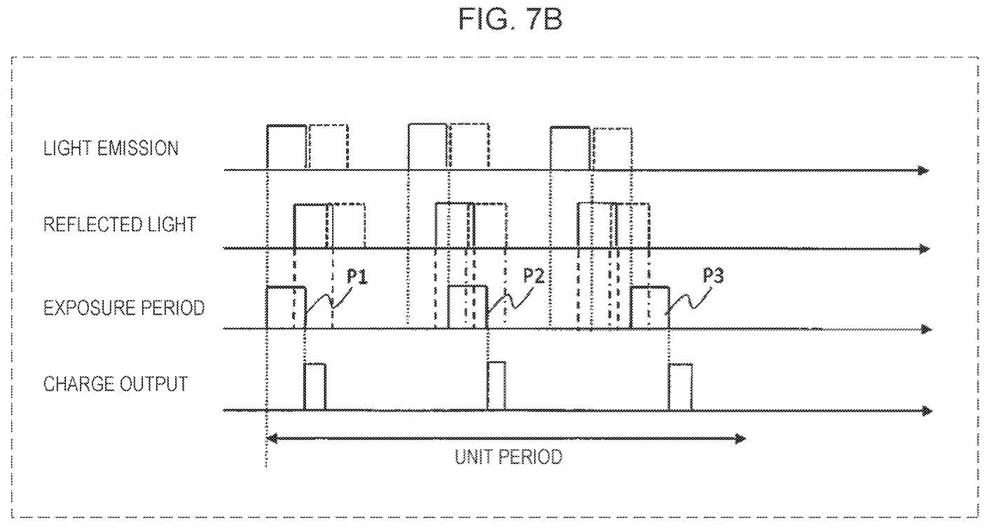

FIG. 7A is a diagram illustrating a first example of a light detection operation for a case where two light beams are consecutively emitted in different directions in each unit period. A horizontal axis represents time. In this example, the exposure operation is performed three times consecutively in a unit period.

FIG. 7A(a) shows timings at which two light beams are respectively emitted from the light source 110. FIG. 7A(b) shows timings at which two pieces of reflected light generated when the two light beams emitted from the light source 110 are diffused by an object respectively reach the image sensor in the light receiving device 120. In this example, when an emission of a first light beam shown by a solid line ends, immediately an emission of a second light beam shown by a broken line starts. Each of two pieces of reflected light corresponding to these light beams reaches the image sensor a little later than the emission timing of the corresponding one of the light beams. The first light beam and the second light beam are different in their emission directions, and the reflected light beams of these first and second light beams are incident on two different light receiving elements or two light receiving element groups in the image sensor. FIGS. 7A(c), 7A(d), and 7A(e) respectively show first to third exposure periods. In this example, the first exposure period starts as the same time when the emission of the first light beam starts, and the first exposure period ends at the same time when the emission of the first light beam ends. The second exposure period starts as the same time when the emission of the second light beam starts, and the second exposure period ends at the same time when the emission of the second light beam ends. The third exposure period starts at the same time as the end of the emission of the second light beam, and ends when a time width the same length as the pulse width of the light beam elapses. FIG. 7A(f) shows a shutter opening period of the image sensor. FIG. 7A(g) shows a period in which a charge is output from each light receiving element.

In the present example, each light receiving element of the image sensor independently accumulates charges generated by the photoelectric conversion in the three exposure periods. The charges accumulated in the respective charge accumulation periods are read out simultaneously. In order to realize this operation, each light receiving element has three or more charge accumulation units. The accumulation of the charge into these charge accumulation units is switched, for example, by a switch. The length of each exposure period is set to be shorter than the shutter opening period. The image sensor opens the shutter to start an exposure operation when the emission of the first light beam starts. The shutter is kept open for a period of time in which there is a possibility that reflected light is received. At the end of the third exposure period, which is the period during which the reflected light generated by the last light beam can be received, the image sensor closes the shutter and ends the exposure operation. When the shutter opening period ends, the image sensor reads out signals. In this signal reading process, signals corresponding to the respective charges accumulated during the first to third charge accumulation periods are read out for each pixel. The read signals are sent, as light reception data, to the signal processing circuit 140. Based on the light reception data, the signal processing circuit 140 can calculate the distance for the light receiving element that has received the reflected light by the method described above with reference to FIG. 6A.

In the example shown in FIG. 7A, a plurality of charge accumulation units are required for each light receiving element, but the charges stored in the plurality of charge accumulation units can be output at once. This makes it possible to repeat the light emission operation and the exposure operation in a shorter time.

FIG. 7B is a diagram illustrating a second example of a light detection operation for a case where two light beams are consecutively emitted in different directions in each unit period. In the example shown in FIG. 7B, as in the example shown in FIG. 6B, the charge is output each time the exposure period ends. In one unit period, a sequence of an operation of emitting a first and second light beams, an exposure operation, and a charge output operation is executed three times. In a first execution of the sequence, the exposure operation of each light receiving element is started at the same time when the emission of the first light beam is started, and the exposure operation is ended at the same time when the emission of the first light beam is ended. Here, the exposure period P1 corresponds to the first exposure period shown in FIG. 7A. When the exposure period P1 ends, the charge accumulated in each light receiving element is read out. In a second execution of the sequence, the exposure operation of each light receiving element is started at the same time when the emission of the first light beam is ended, that is, when the emission of the second light beams is started, the exposure operation of each light receiving element is started, and the exposure operation is ended when the emission of the second light beam is ended. This exposure period P2 corresponds to the second exposure period shown in FIG. 7A. When the exposure period P2 ends, the charge accumulated in each light receiving element is read out. In the third execution of the sequence, at the same time as the end of the emission of the second light beam, the exposure operation of each light receiving element starts, and the exposure operation ends when a time with the same length as the pulse width of each light beam elapses. This exposure period P3 corresponds to the third exposure period shown in FIG. 7A. When the exposure period P3 ends, the charge accumulated in each light receiving element is read out. In this example, in each unit period, a sequence of operations including consecutive emissions of a plurality of light beams, an exposure operation, and reading of light reception data is repeated three times. Thus, as in the example shown in FIG. 7A, it is possible to acquire light reception data according to the amount of charge in each exposure period for each light receiving element. As a result, the distance can be calculated by performing the above-described calculation.

In the example shown in FIG. 7B, each light receiving element needs to have only one charge accumulation unit, which makes it possible to simplify the structure of the image sensor.

In the examples shown in FIGS. 7A and 7B, each unit period includes three exposure periods, but the number of exposure periods per unit period may be equal to or smaller than two or equal to or larger than four. For example, in a case where the light source used is capable of emitting light beams in a plurality of directions at the same time, the number of exposure periods per unit period may be two. In this case, the distance can be calculated by the method described above with reference to FIG. 6A or FIG. 6B. In a case the distance is calculated by a direct ToF method described later, the number of exposure periods per unit period may be one. The number of light beams emitted per unit period is not limited to two, but may be three or more. The timings of light emission and light reception may be adjusted depending on the setting of the reach range of a plurality of light beams.

### 1-1-2 Configuration of Light Source 110

Next, an example of a configuration of the light source 110 is described. The light source 110 is a light emitting device capable of changing the light beam emission direction under the control of the control circuit 130. Hereinafter, the light emitting device of this type may be referred to as a “light scanning device”. The light scanning device emits the light beam such that part of a region of a scene to be subjected to the distance measurement is sequentially irradiated with the light beam. In order to realize this function, the light scanning device includes a mechanism for changing the emission direction of the light beam. For example, the light scanning device may include a light emitting element such as a laser and at least one working mirror, such as a MEMS mirror. The light emitted from the light emitting element is reflected by the working mirror and heads for a particular region in the scene to be subjected to the distance measurement. The control circuit 130 can change the emission direction of the light beam by driving the working mirror.

The light emitting device used may have a mechanism different from the above-described mechanism using the working mirror for changing the emission direction of the light beam. For example, the light emitting device used here may be such a light emitting device using a reflective waveguide disclosed in Japanese Unexamined Patent Application Publication No. 2018-124271. Alternatively, the light emitting device may be such one that adjusts the phase of each of antennas included an antenna array thereby changing the overall direction of light emitted by the antenna array.

Next, an example of a configuration of the light source 110 is described.

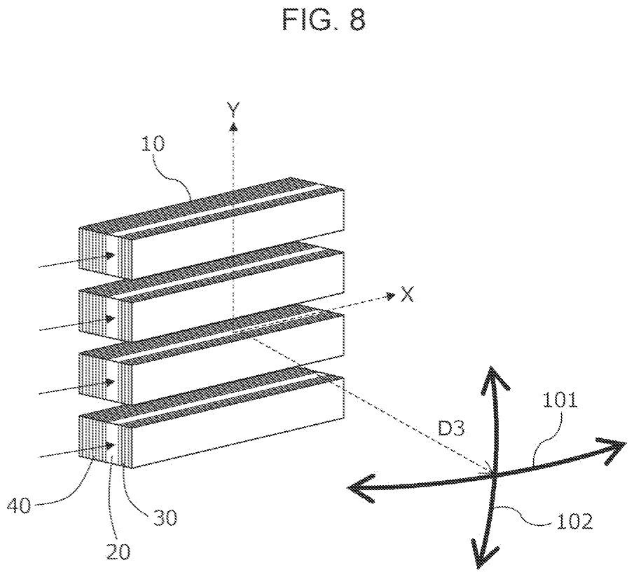

FIG. 8 is a perspective view schematically illustrating an example of a light emitting device used in the light source 110. The light source 110 may be configured by a combination of a plurality of light emitting devices, each of which emits light in a different direction. FIG. 8 shows, in a simplified fashion, a configuration of one of the light emitting devices.

The light emitting device includes an optical waveguide array including a plurality of optical waveguide elements 10. Each of the plurality of optical waveguide elements 10 has a shape extending in a first direction (an X direction in FIG. 8). The plurality of optical waveguide elements 10 are regularly arranged in a second direction (a Y direction in FIG. 8) intersecting the first direction. When the plurality of optical waveguide elements 10 propagate light in the first direction, light is emitted in a third direction D3 intersecting a virtual plane parallel to the first and second directions.

Each of the plurality of optical waveguide elements 10 includes a first mirror 30 and a second mirror 40 opposing each other, and an optical waveguide layer 20 located between the mirror 30 and the mirror 40. Each of the mirror 30 and the mirror 40 has, at the interface with the optical waveguide layer 20, a reflective surface intersecting the third direction D3. The mirror 30, the mirror 40, and the optical waveguide layer 20 each have a shape extending in the first direction.

The reflective surface of the first mirror 30 and the reflective surface of the second mirror 40 face each other substantially in parallel. Of the two mirrors 30 and the mirror 40, at least the first mirror 30 has a property of transmitting part of light propagating in the optical waveguide layer 20. In other words, the first mirror 30 has a higher light transmittance than that of the second mirror 40 for the light propagating in the light waveguide layer 20. As a result, part of the light propagating in the optical waveguide layer 20 is emitted to the outside from the first mirror 30. The mirrors 30 and 40 configured in the above-described manner may be realized by a multilayer mirror formed by a multilayer film (also referred to as a multilayer reflective film) made of, for example, a dielectric.

It is possible to emit light in any desired direction by adjusting the phase of light input to each optical waveguide element 10, and further by adjusting the refractive index or the thickness of the optical waveguide layer 20 in these optical waveguide elements 10 or adjusting the wavelength of light input to the optical waveguide layer 20.

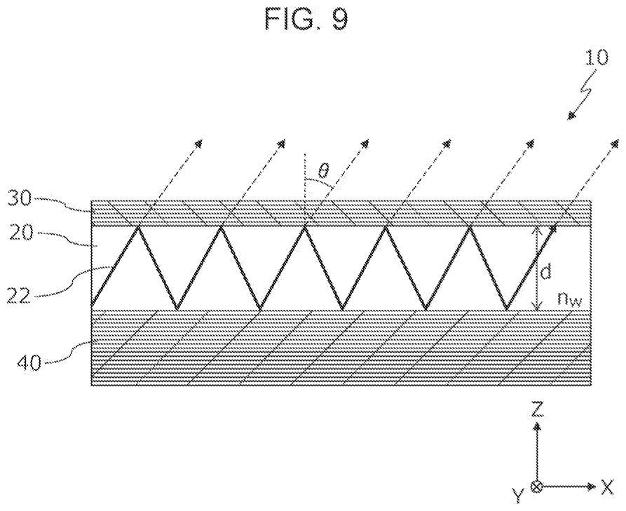

FIG. 9 is a diagram schematically illustrating an example of a cross-sectional structure of the optical waveguide element 10 and an example of propagating light. In FIG. 9, a Z direction is defined by a direction perpendicular to both the X direction and the Y direction shown in FIG. 8, and a cross section parallel to the XZ plane of the optical waveguide element 10 is schematically illustrated. In the optical waveguide element 10, the pair of mirrors 30 and 40 is arranged such that the optical waveguide layer 20 is located between the mirrors 30 and 40. Light 22 is input to optical waveguide layer 20 from its one end as seen in the X direction and propagates in the optical waveguide layer 20 while being repeatedly reflected by the first mirror 30 provided on the upper surface of the optical waveguide layer 20 and the second mirror 40 provided on the lower surface of the optical waveguide layer 20. The first mirror 30 has a higher light transmittance than the second mirror 40. Thus, it is possible to output part of the light mainly from the first mirror 30.

In a usual optical waveguide such as an optical fiber, light propagates along the optical waveguide while being repeatedly subjected to total reflection. In contrast, in the optical waveguide element 10 according to the present embodiment, light propagates while being repeatedly reflected by the mirrors 30 and 40 arranged above and below the optical waveguide layer 20. Therefore, there are no restrictions on the light propagation angle. Note that the light propagation angle refers to the angle of incidence on the interface between the mirror 30 or the mirror 40 and the optical waveguide layer 20. Light incident at an angle closer to the perpendicular on the mirror 30 or 40 can also propagate. That is, light incident on the interface at an angle smaller than the critical angle of total reflection can also propagate. Therefore, the group velocity of light in the propagation direction of light is significantly lower than the speed of light in free space. Thus, the optical waveguide element 10 has a property that light propagation conditions change significantly with respect to changes in the wavelength of light, the thickness of the optical waveguide layer 20, and the refractive index of the optical waveguide layer 20. Such an optical waveguide is referred to as a “reflective optical waveguide” or a “slow light optical waveguide”.

The emission angle θ of light emitted from the optical waveguide element 10 into the air is expressed by an equation (1) shown below.

$$sin θ = \sqrt{{n}_{w}^{2} - {( \frac{m λ}{2 d} )}^{2}} \qquad ( 1 )$$

As can be seen from equation (1), the light emission direction can be changed by changing one of the wavelength λ of the light in the air, the refractive index n_{w} of the optical waveguide layer 20, and the thickness d of the optical waveguide layer 20.

For example, when n_{w}=2, d=387 nm, λ=1550 nm, and m=1, the emission angle is 0°. In this state, if the refractive index is changed to n_{w}=2.2, then the emission angle changes to about 66°. On the other hand, if the thickness is changed to d=420 nm without changing the refractive index, then the emission angle changes to about 51°. If the wavelength is changed to λ=1500 nm without changing the refractive index and the thickness, then the emission angle changes to about 30°. As described above, the light emission direction can be changed by changing one of the wavelength λ of the light, the refractive index n_{w} of the optical waveguide layer 20, and the thickness d of the optical waveguide layer 20.

The wavelength λ of light may be in a wavelength range from 400 nm to 1100 nm (from visible light to near-infrared light) in which the image sensor can have high detection sensitivity, for example, in general, by absorbing light with silicon (Si). In an alternative example, the wavelength λ may be in a wavelength range of near infrared light from 1260 nm to 1625 nm in which an optical fiber or a Si optical waveguide has a relatively low transmission loss. Note that these wavelength ranges are merely examples. The wavelength range of light used is not limited to a wavelength range of visible light or infrared light, and may be, for example, a wavelength range of ultraviolet light.

The light emitting device may include a first adjustment element that changes at least one of the refractive index, thickness, or wavelength of the optical waveguide layer 20 in each optical waveguide element 10. This makes it possible to adjust the direction of emitted light.

In order to adjust the refractive index of at least part of the optical waveguide layer 20, the optical waveguide layer 20 may include a liquid crystal material or an electro-optical material. The optical waveguide layer 20 may be disposed between a pair of electrodes. By applying a voltage to the pair of electrodes, it is possible to change the refractive index of the optical waveguide layer 20.

In order to adjust the thickness of the optical waveguide layer 20, for example, at least one actuator may be connected to at least one of the first mirror 30 or the second mirror 40. It is possible to change the thickness of the optical waveguide layer 20 by changing the distance between the first mirror 30 and the second mirror 40 using at least the one actuator. In a case where the optical waveguide layer 20 is formed of a liquid, the thickness of the optical waveguide layer 20 can be easily changed.

In the optical waveguide array in which the plurality of optical waveguide elements 10 are arranged in one direction, the light emission direction changes due to the interference of light emitted from the respective optical waveguide elements 10. By adjusting the phase of the light supplied to each optical waveguide element 10, it is possible to change the light emission direction. The principle thereof is described below.

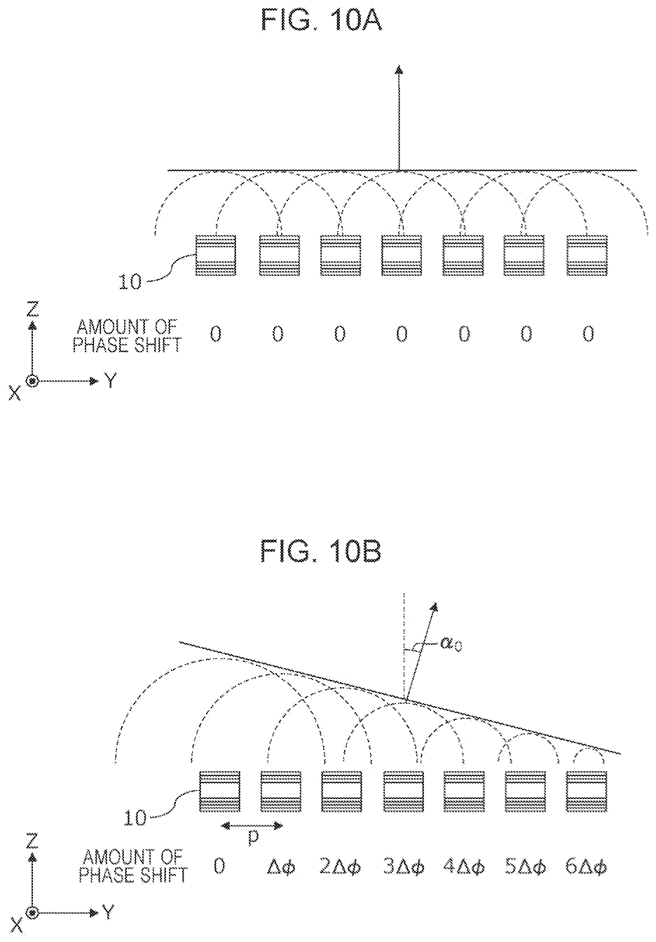

FIG. 10A is a diagram illustrating a cross section of an optical waveguide array that emits light in a direction perpendicular to an emission surface of the optical waveguide array. FIG. 10A also illustrates the amount of phase shift of the light propagating through each optical waveguide element 10. Here, the amount of the phase shift is given by a value with respect to the phase of the light propagating through the optical waveguide element 10 at the left end. The optical waveguide array according to the present embodiment includes a plurality of optical waveguide elements 10 arranged at equal intervals. In FIG. 10A, dashed arcs each indicate a wavefront of light emitted from one of the optical waveguide elements 10. A straight line indicates a wavefront formed by the interference of light. An arrow indicates the direction of the light emitted from the optical waveguide array (that is, the direction of the wave number vector). In the example shown in FIG. 10A, the phases of the light propagating in the optical waveguide layers 20 in the respective optical waveguide elements 10 are the same. In this case, the light is emitted in a direction (the Z direction) perpendicular to both the arrangement direction (the Y direction) in which the optical waveguide elements 10 are arranged and a direction (the X direction) in which the optical waveguide layer 20 extends.

FIG. 10B is a diagram showing a cross section of an optical waveguide array that emits light in a direction different from the direction perpendicular to the exit surface of the optical waveguide array. In the example shown in FIG. 10B, phases of the light propagating in the optical waveguide layers 20 in the respective optical waveguide elements 10 are different by a particular amount (Δφ) in the arrangement direction from one optical waveguide element to another. In this case, the light is emitted in a direction different from the Z direction. By changing this ΔΦ, it is possible to change the Y-direction component of the wave number vector of light. When the center-to-center distance between two adjacent optical waveguide elements 10 is denoted by p, the light emission angle α₀ is expressed by an equation (2) shown below.

$$sin {α}_{0} = \frac{Δϕλ}{2 π p} \qquad ( 2 )$$

When the number of the optical waveguide elements 10 is N, the spread angle Δα of the light emission angle is expressed by an equation (3) shown below.

$$Δ α = \frac{2 λ}{Np cos {α}_{0}} \qquad ( 3 )$$

Therefore, the larger the number of the optical waveguide elements 10, the smaller the spread angle Δα can be.

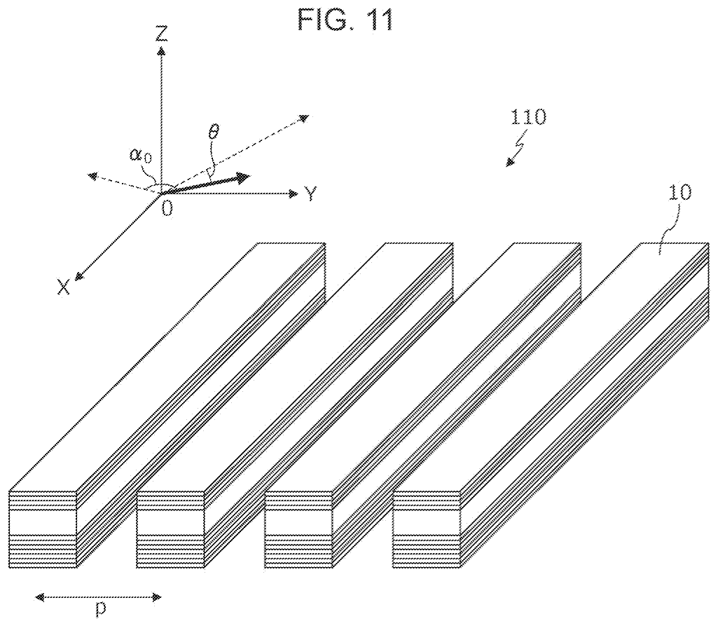

FIG. 11 is a perspective view schematically showing an optical waveguide array in a three-dimensional space. In FIG. 11, a thick arrow indicates the direction of the light emitted from the light emitting device. θ is the angle formed by the light emission direction and the YZ plane. θ satisfies equation (2). α₀ is the angle formed by the light emission direction and the XZ plane. α₀ satisfies equation (3).

In order to control the phase of the light emitted from each optical waveguide element 10, for example, a phase shifter may be provided for changing the phase of the light before light is input to the optical waveguide element 10. The light emitting device may include a plurality of phase shifters connected to the respective optical waveguide elements 10, and a second adjustment element for adjusting the phase of the light propagating through each phase shifter. Each phase shifter includes an optical waveguide that connects directly to or via another optical waveguide to the optical waveguide layer 20 of the corresponding one of the plurality of optical waveguide elements 10. The second adjustment element changes the direction (the third direction D3) of the light emitted from the plurality of optical waveguide elements 10 by changing the phase difference of light propagating from the plurality of phase shifters to the plurality of optical waveguide elements 10. Hereinafter, a plurality of phase shifters arranged in a similar manner to the optical waveguide array may be referred to as a “phase shifter array”.

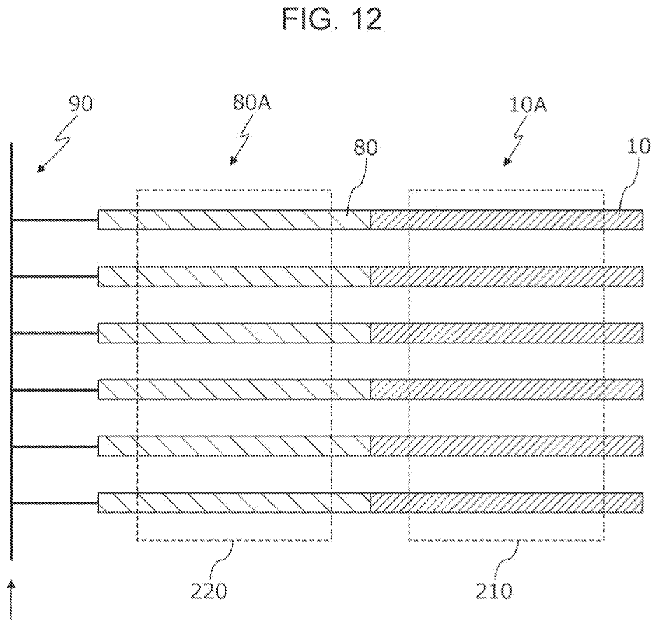

FIG. 12 is a schematic diagram illustrating an optical waveguide array 10A and a phase shifter array 80A as viewed from a direction (the Z direction) normal to the light emitting surface. In the example shown in FIG. 12, all the phase shifters 80 have the same propagation characteristics, and all the optical waveguide elements 10 have the same propagation characteristics. The phase shifters 80 may be or may not be equal in length to each other, and the optical waveguide elements 10 may be or may not be equal in length to each other. In a case where the lengths of the respective phase shifters 80 are equal, for example, the amount of phase shift given by each phase shifter 80 may be controlled by a driving voltage. Alternatively, the lengths of the respective phase shifters 80 may be changed in equal steps. In this case, it is possible to obtain phase shifts changing in equal steps by applying the same driving voltage. The light emitting device further includes an optical divider 90 for dividing light and supplying the divided light to the plurality of phase shifters 80, a first drive circuit 210 that drives the optical waveguide elements 10, and a second drive circuit 220 that drives the phase shifters 80. In FIG. 12, a straight arrow indicates a light input. By independently controlling the first drive circuit 210 and the second drive circuit 220, which are provided separately, the light emission direction can be changed two-dimensionally. In this example, the first drive circuit 210 functions as one element of the first adjustment element, and the second drive circuit 220 functions as one element of the second adjustment element.

The first drive circuit 210 changes the angle of light emitted from the optical waveguide layer 20 by changing at least one of the refractive index or the thickness of the optical waveguide layer 20 in each optical waveguide element 10. The second drive circuit 220 changes the phase of light propagating inside the optical waveguide 20a by changing the refractive index of the optical waveguide 20a in each phase shifter 80. The optical divider 90 may be configured by an optical waveguide in which light propagates by total reflection, or may be configured by a reflective optical waveguide similar to the optical waveguide element 10.

After controlling the phase of each pieces of light divided by the optical divider 90, each piece of resultant light may be input to the phase shifter 80. For this phase control, for example, a passive phase control structure may be used for adjusting the length of the optical waveguide to the phase shifter 80. Alternatively, a phase shifter may be used which is controlled by an electric signal to achieve a function similar to that of the phase shifter 80. By using such a method, for example, the phase may be adjusted before the light is supplied to the phase shifter 80 such that the light supplied to any phase shifter 80 is equal in phase. Performing the adjustment in the above-described manner makes it possible to simplify the control of each phase shifter 80 performed by the second drive circuit 220.

Details of the operation principle and the operation method of the above-described light emitting device are disclosed in Japanese Unexamined Patent Application Publication No. 2018-124271. The entire contents disclosed in Japanese Unexamined Patent Application Publication No. 2018-124271 are incorporated herein by reference.

The light source 110 according to the present embodiment may be realized by combining a plurality of waveguide arrays, each of which emits light in different directions. An example of a configuration of such a light source 110 is described below.

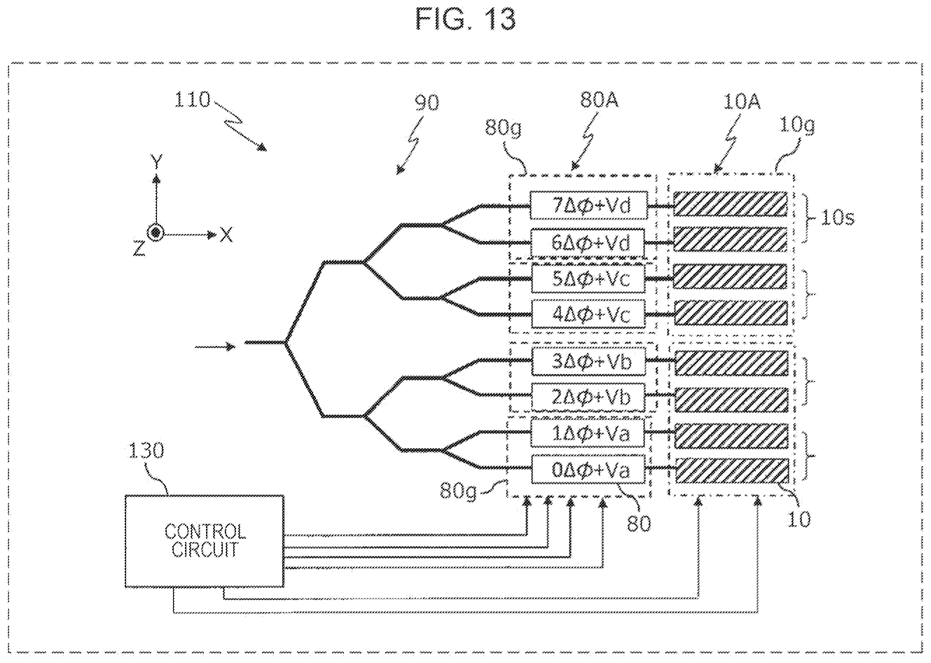

FIG. 13 is a diagram illustrating an example of the light source 110. In this example, the light source 110 includes an optical waveguide array 10A and a phase shifter array 80A connected to the optical waveguide array 10A. The optical waveguide array 10A includes a plurality of optical waveguide groups 10g arranged in a Y direction. Each optical waveguide group 10g includes one or more optical waveguide elements 10. The phase shifter array 80A includes a plurality of phase shifter groups 80g arranged in the Y direction. Each phase shifter group 80g includes one or more phase shifters 80. In this example, the phase shifter groups 80g do not correspond in a one-to-one manner to the optical waveguide group 10g. More specifically, two phase shifter groups 80g are connected to one optical waveguide group 10g.

The amount of phase shift of each phase shifter 80 is individually controlled by the control circuit 130. The amount of phase shift of each phase shifter 80 is controlled such that it is given by the sum of a first amount of phase shift (an integer multiple of Δφ) depending on the its position in the array and a second amount of phase shift (one of Va, Vb, Vc, and Vd) varying depending on each phase shifter group 80g. By changing the second amount of phase shift for each phase shifter group 80g, the Y component of the emission direction of the light beam and the spread angle in the Y direction of the spot size are controlled.

The control circuit 130 individually determines the value of the applied voltage for each optical waveguide group 10g. By controlling the voltage applied to each optical waveguide group 10g, the X component of the emission direction of the light beam is controlled. The light emission direction is determined according to combinations of phase shifter groups 80g and optical waveguide groups 10g. In the example shown in FIG. 13, light is emitted in the same direction from two adjacent optical waveguide groups 10s connected to one phase shifter group 80g. If one light beam is given by a flux of light emitted from one optical waveguide group 10g, then in the example shown in FIG. 13, two light beams can be emitted at the same time. By increasing the number of optical waveguide elements 10 and the number of phase shifters 80, it is possible to further increase the number of beams.

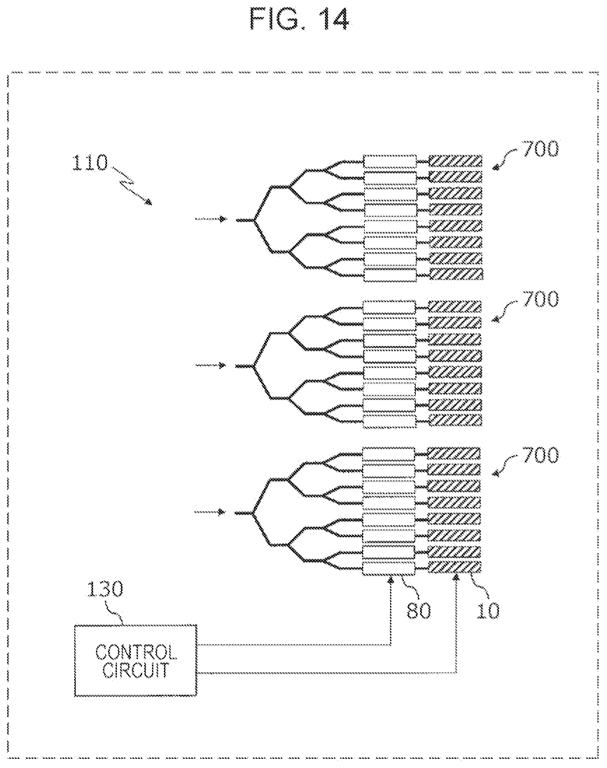

FIG. 14 is a diagram illustrating another example of a configuration of the light source 110. In this example, the light source 110 includes a plurality of light emitting devices 700, each of which emits a light beam in a different direction. In this example, a plurality of phase shifters 80 and a plurality of optical waveguide elements 10 are disposed on one chip. The control circuit 130 controls the voltage applied to each phase shifter 80 and each optical waveguide element 10 in each light emitting device 700 thereby controlling the direction of the light beam emitted from each light emitting device 700. In this example, the light source 110 includes three light emitting devices 700, but may include a larger number of light emitting devices 700. Each of a set of short-range beams and a set of long-range beams may include a set of light beams emitted from the plurality of light emitting devices 700.

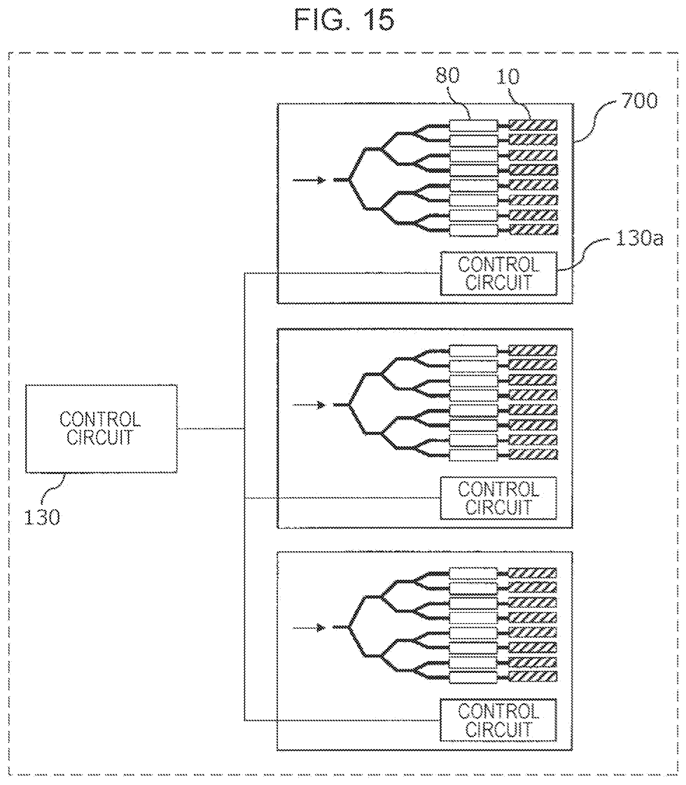

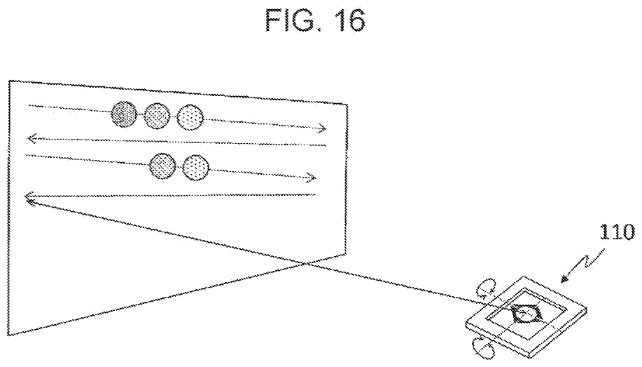

FIG. 15 is a diagram illustrating still another example of a configuration of the light source 110. In this example, the light source 110 includes a plurality of light emitting devices 700, each of which is disposed on a different chip. The plurality of light emitting devices 700 emit light beams in different directions. Each light emitting device 700 includes a control circuit 130a that determines voltages applied to a plurality of phase shifters 80 and a plurality of optical waveguide elements 10. The control circuit 130a in each light emitting device 700 is controlled by an external control circuit 130. In this example, the light source 110 also includes three light emitting devices 700, but the light source 110 may include a greater number of light emitting devices 700. Each of a set of short-range beams and a set of long-range beams may include a set of light beams emitted from the plurality of light emitting devices 700.

FIG. 16 is a diagram illustrating still another example of the light source 110. In this example, the light source 110 includes a light emitting element such as a laser and at least one movable mirror, such as a MEMS mirror. Light emitted from the light emitting element is reflected by the movable mirror and propagates to a predetermined area in a target area (represented as a rectangle in FIG. 16). The control circuit 130 changes the direction of the light emitted from the light source 110 by driving the movable mirror such that the target area is scanned with light, for example, as shown by dotted arrows in FIG. 16.

### 1-1-3 Configuration of Light Receiving Device 120

Next, an example of a configuration of the light receiving device 120 is described.

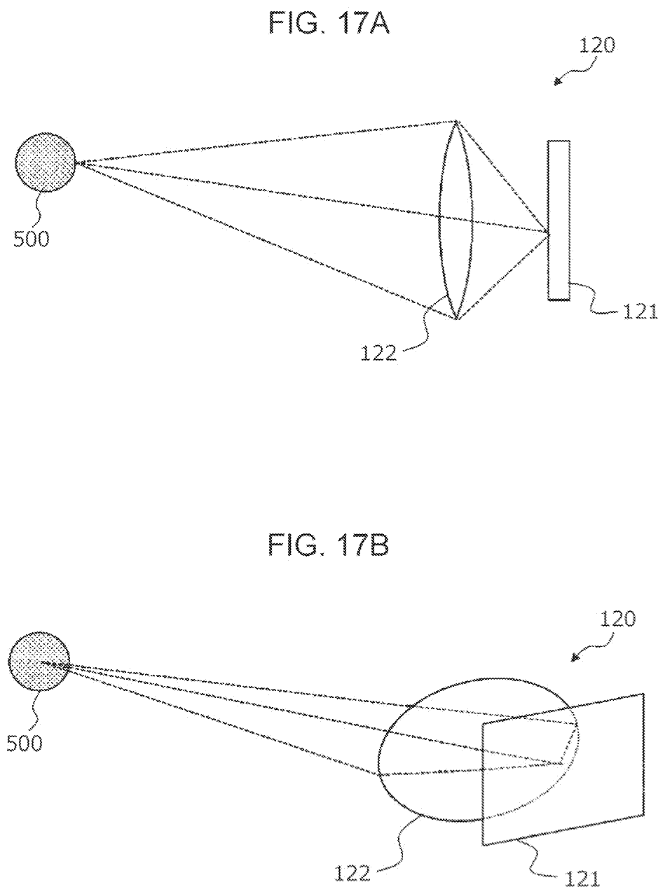

FIG. 17A is a side view schematically illustrating an example of a configuration of the light receiving device 120. FIG. 17B is a perspective view schematically illustrating an example of a configuration of the light receiving device 120. The light receiving device 120 includes an image sensor 121 in which a plurality of light receiving elements are arranged in a two-dimensional manner, and an optical system 122. The plurality of light receiving elements are two-dimensionally arranged on a light receiving surface of the image sensor 121. The optical system 122 may include, for example, at least one lens. The optical system 122 may include other optical elements such as a prism, a mirror, and/or the like. The optical system 122 is designed such that light diffused from one point of an object 500 in a scene is focused on one point on the light receiving surface of the image sensor 121.

The image sensor 121 may be, for example, a CCD (Charge-Coupled Device) sensor, a CMOS (Complementary Metal Oxide Semiconductor) sensor, or an infrared array sensor. Each light receiving element includes a photoelectric conversion element such as a photodiode and one or more charge accumulation units. Charge generated by the photoelectric conversion is accumulated in the charge accumulation unit for an exposure period. The charge accumulated in the charge accumulation unit is output after the end of the exposure period. Thus, each light receiving element outputs an electric signal depending on the amount of light received in the exposure period. This electric signal is referred to as “light reception data”. The image sensor 121 may be a monochrome image sensor or a color image sensor. For example, the image sensor 121 may be a color imaging device having an R/G/B filter, an R/G/B/IR filter, or an R/G/B/W filter. The image sensor 121 may be sensitive not only in the visible wavelength range but also in other wavelength ranges such as an ultraviolet range, a near infrared range, a mid-infrared range, and/or a far infrared range. The image sensor 121 may be a sensor using a SPAD (Single Photon Avalanche Diode). The image sensor 121 may include an electronic shutter capable of performing a signal exposure operation for all pixels at a time, that is, a global shutter mechanism.

### 1-1-4 Configuration of Signal Processing Circuit 140

As shown in FIG. 3, the signal processing circuit 140 includes a memory 141 and a processor 148 such as a CPU and/or a GPU that processes a signal output from the image sensor 121 of the light receiving device 120. The processor 148 of the signal processing circuit 140 shown in FIG. 3 includes a distance calculation unit 142 and a distance image synthesis unit 143. The distance calculation unit 142 calculates the distance associated with each pixel based on the signal output from the image sensor 121. The distance image synthesis unit 143 generates a distance image based on the distance information associated with each pixel. The functions of the distance calculation unit 142 and the distance image synthesis unit 143 may be realized, for example, by the processor 148 by executing a computer program stored in the memory 141. In that case, the processor 148 functions as the distance calculation unit 142 and the distance image synthesis unit 143. Alternatively, each of these functional unit may be realized by dedicated hardware. The control circuit 130 and the signal processing circuit 140 may be realized by one circuit. For example, one MCU may have the functions of both the control circuit 130 and the signal processing circuit 140. The memory 141 stores the light reception data associated with each light receiving element output from the image sensor 121 and the distance data calculated based on the light reception data for each unit period.

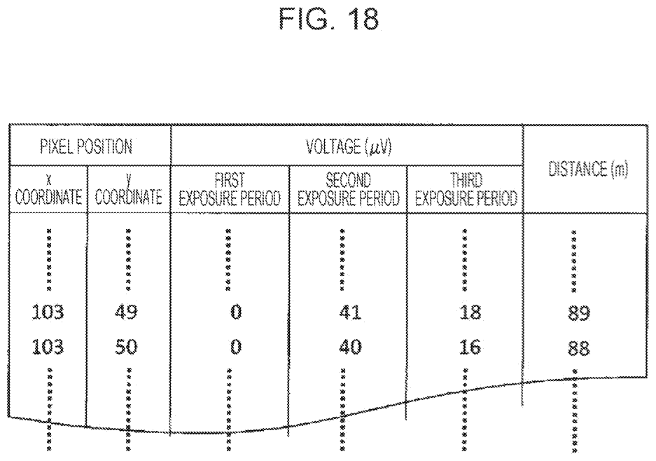

FIG. 18 illustrates an example of data stored in the memory 141. In the example shown in FIG. 18, the data stored in the memory 141 includes xy coordinate values indicating the positions of the respective light receiving elements, values of the amount of charges accumulated in the respective exposure periods expressed in voltages, and distance values calculated from the voltage values. The signal processing circuit 140 stores data such as that shown in FIG. 18 in the memory 141 for each unit period. The data shown in FIG. 18 is merely an example. The format of the data may be appropriately modified.

### 1-2 Operation of Distance Measurement Apparatus 100

The operation of the distance measurement apparatus 100 is described in further detail below.

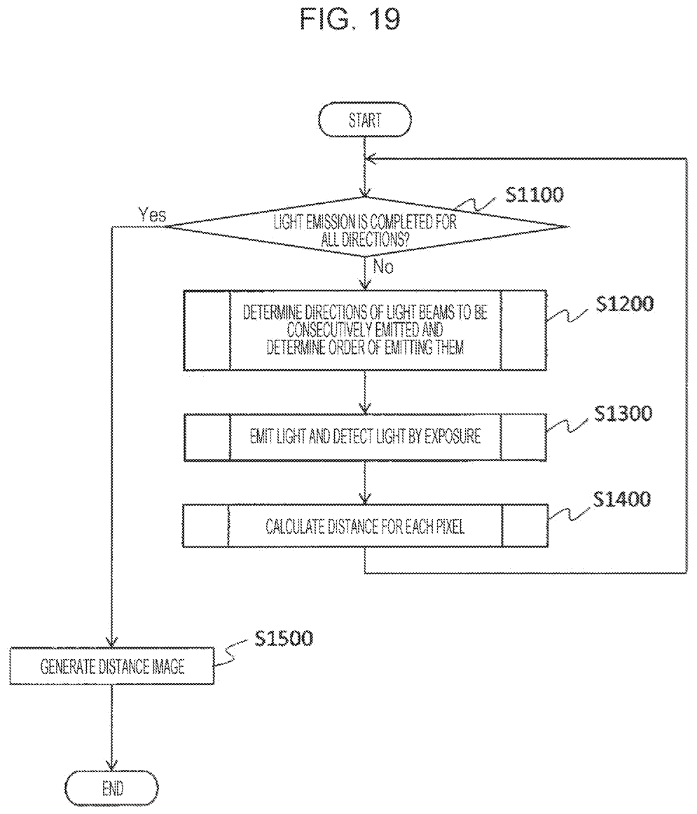

FIG. 19 is a flowchart illustrating an outline of an operation of the distance measurement apparatus 100 according to the present embodiment. The distance measurement apparatus 100 executes the operation including steps from S1100 to S1500 shown in FIG. 19. Each step of the operation is described below.

### Step S1100

The control circuit 130 refers to light beam information (see FIG. 4) stored in the memory 131, and determines whether or not the emitting of light is completed for all directions. In a case where the emitting of light is completed for all directions, the process proceeds to step S1500. If there is a direction in which the emitting of light has not yet been performed, the process proceeds to step S1200.

### Step S1200

The control circuit 130 makes a determination, regarding unprocessed beam directions of the beams directions stored in the memory 131, as to a combination of directions of a plurality of light beams to be continuously emitted in a unit period and an emission order thereof. The combination of light beam directions is determined such that a plurality of pieces of reflected light corresponding to the plurality of light beams are incident on a plurality of points on the light receiving surface of the image sensor 121 regardless of the position of an object in a scene. That is, the plurality of pieces of reflected light originating from the respective consecutively emitted light beams are received by different light receiving elements on the light receiving surface of the image sensor 121.

The order of emitting the light beams may be determined so as to minimize the time required to switch the light emission directions. For example, in a case where the light source 110 adjusts the emission directions using a two-axis MEMS mirror, the order of emitting the light beams may be determined so as to minimize the number of and the amounts of adjustments of the MEMS mirror about a low-speed axis and, under this condition, to minimize the amount of the adjustment about a high-speed axis. Also in a case where the emitting of light is performed using other types of light scanning device including no MEMS mirror, when the directions of the light beams are adjusted according to a plurality of adjustment items (for example, parameters or axes), the order of emitting the light beams may be determined from the same viewpoint. In a case where the time required for the adjustment varies depending on the adjustment items, the order of emitting the light beams may be determined so as to minimize the number of and the amounts of adjustments on lower-speed adjustment items, and, under this condition, to minimize the amounts of adjustment on higher-speed adjustment items. In addition to the order of emitting the light beams, the control circuit 130 also determines the timing of emitting each light beam and the timing of the exposure operation by the image sensor 121.

### Step S1300

The control circuit 130 instructs the light source 110 to emit light according to the determined order and timing of light emission. The control circuit 130 also instructs the light receiving device 120 to start and end the exposure operation according to the determined exposure timing. Thus, the light receiving device 120 measures the amount of charge accumulated in each light receiving element for each exposure period, and stores resultant information in the memory 141 of the signal processing circuit 140.

### Step S1400

The signal processing circuit 140 calculates the distance for each pixel based on the information on the charge stored in the memory 141. More specifically, the signal processing circuit 140 determines the distance associated with each pixel based on the values of charge acquired in each of the plurality of exposure periods for the pixel. Based on the relative amounts of charges obtained in the respective exposure periods, the flight time of light is calculated thereby determining the distance to the object. The signal processing circuit 140 stores the calculated distance in the memory 141.

### Step S1500

When the light emission is completed for all the preset directions for one unit period, the signal processing circuit 140 generates a distance image. In generating the distance image, for example, the signal processing circuit 140 replaces the distance value stored for each pixel in step S1400 with a color scale. The distance image is not limited to being represented in the color scale, but the distance may be represented two-dimensionally in other expression forms, for example, in a grayscale. The signal processing circuit 140 may generate and output data indicating the distance or distances of one or more objects without generating a distance image.

1-2-1 Determining the Combination of Light Emission Directions and the Order of Emitting Light Beams

An example of a method of determining the combination of light emission directions and the order of emitting light beams according to the present embodiment is described below.

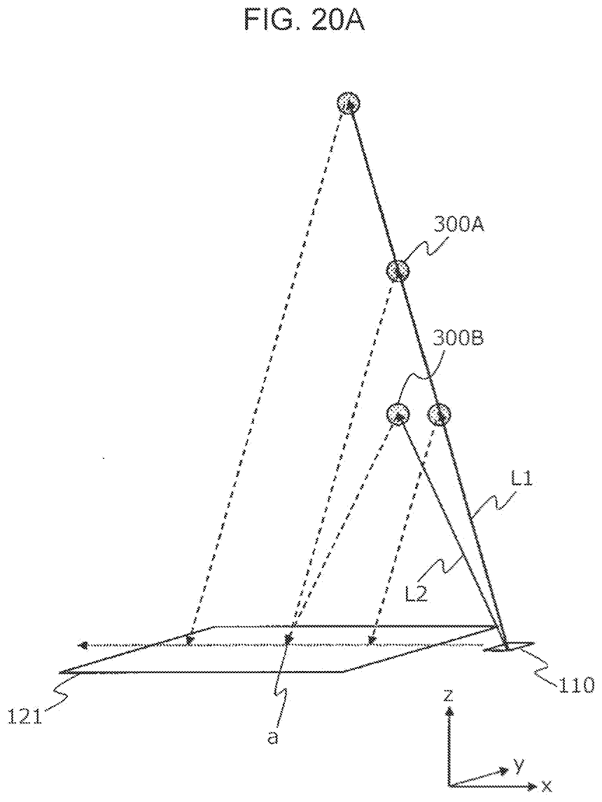

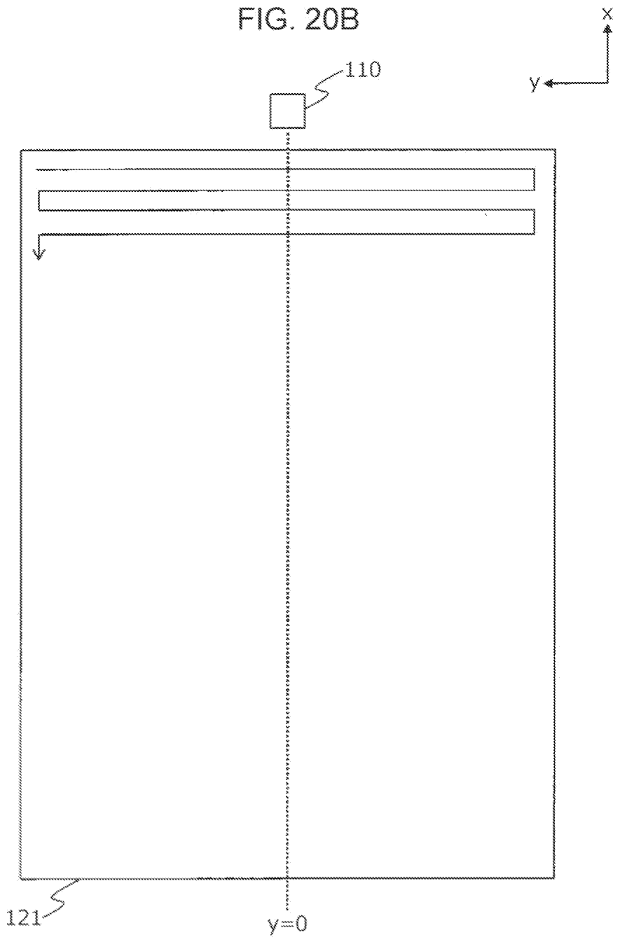

FIG. 20A is a diagram schematically illustrating a relationship among a direction of a light beam emitted from the light source 110, a position of an object, and a light reception position of the image sensor 121. As shown in FIGS. 17A and 17B, light diffused at a point in a scene (referred to herein as “reflected light”) is focused via a lens of the optical system 122 on a specific position on the light receiving surface corresponding to the position in the scene. In a case where the optical system 122 is a lens, the focal point is at a point where a straight line extending from a point at which light is diffused in a scene passing through the center of the lens intersects with the light receiving surface of the image sensor 121. As shown by solid arrows in FIG. 20A, when light beams are emitted in specific directions in a scene, light is diffused by an object existing on a straight line in the direction of light emission, and reflected light is generated as indicated by dashed arrows. The position on the image sensor 121 on which the reflected light is incident depends on the position of the reflecting object. Nevertheless, the reflected light from the object located on the straight line in the light emission direction is focused on a straight line which is obtained when a straight line in a light emission direction is projected on the light receiving surface of the image sensor 121. Although the position of the object is unknown at the time of the distance measurement, the position on the light receiving surface on which the reflected light is incident is limited to being located on the straight line obtained by projecting the light emission direction onto the light receiving surface in the emission direction.

When light beams are emitted in the same unit period in a plurality of directions whose projections onto the light receiving surface overlap each other, there is a possibility that a plurality pieces of reflected light originating from these emitted light beams are incident on the same point on the light receiving surface. For example, in the case shown in FIG. 20A, a light beam L1 and a light beam L2 are respectively emitted in directions whose projections onto the light receiving surface of the image sensor 121 overlap each other. Here, x, y, and z coordinate axes are defined such that they are orthogonal to each other as shown in FIG. 20A. More specifically, the x direction and the y direction are respectively defined in longitudinal and lateral directions of the light receiving surface of the image sensor 121, and the z direction is defined in the direction which is perpendicular to both the x and y directions and on the side into which light is emitted. In a case where the coordinate system is set in the above-described manner, the light beam L1 and the light beam L2 have common x and y components of unit vectors taken along the respective emission directions. In the example shown in FIG. 20A, reflected light generated when the light beam L1 is diffused by an object 300A, and reflected light generated when the light beam L2 is diffused by another object 300B are incident on the same point a on the light receiving surface. In this case, a light receiving element located at the point a receives both the reflected light from the object 300A and the reflected light from the object 300B in the same unit period. In this case, an error occurs in the result of the distance calculation by the indirect ToF method described above. This problem may occur not only when the paths of a plurality of light beams projected onto the light receiving surface overlap each other in the light receiving surface but also when they intersect each other. For example, in a configuration in which a plurality of light sources are used, when a plurality of light beams are emitted from those light sources, if projections of the light emission paths onto the light receiving surface intersect each other, the problem described above can occur.

In the present embodiment, in view of the above, the control circuit 130 determines directions of a plurality of light beams emitted in each unit period such that when paths of the plurality of light beams are projected onto the light receiving surface of the image sensor 121, projected lines do not overlap and do not intersect with each other in the light receiving surface. This makes it possible to prevent each light receiving element from detecting a plurality of pieces of reflected light from different objects in the same unit period.

In the example shown in FIG. 20A, the light source 110 is located at a position close to the image sensor 121 such that the location of the light source 110 is slightly deviated from the image sensor 121 in the +x direction. The location of the light source 110 is on a straight line passing through the center of the image sensor 121 and extending parallel to the x axis. Let the y coordinate of the light source 110 be y=0. In a case where the configuration is set in the above-described manner, it is efficient to perform scanning using the light beam emitted from the light source 110 such that a light receiving position where reflected light originating from the light beam is receivable moves in a manner as represented by a zig-zag arrow in FIG. 20B. Note that the light receiving position represented by the zigzag arrow in FIG. 20B, where the reflected light originating from the light beam is receivable, may be determined assuming that the light beam is to be reflected by an object at a particular distance from the light source 110 or the light receiving device 120. In FIG. 20B, the zigzag arrow schematically shows an example of a time-dependent position at which reflected light originating from the light beam is received by a particular light receiving element of the image sensor 121. In this example, the light receiving position where to receive the reflected light moves along the y direction from one end to the other end of the image sensor 121 in the y direction, and then moves in the −x direction shorter than the previous movement in the y direction and moves along the y direction from the other end to the one end of the image sensor 121 in the y direction, and then moves in the −x direction shorter than the previous movement in the y direction. This movement is repeated until the scanning is completed. In the present embodiment, the entire target scene can be efficiently scanned by reducing the total amount of change in the emission direction of the light beam sequentially emitted from one light source. Thus, in the example shown in FIG. 20B, a plurality of light beams emitted in the same unit period are emitted in directions such that when the light beams are reflected by objects located at the same distance, a plurality pieces of reflected light from the objects are received at positions which are close to each other in the direction shown in FIG. 20B. In a case where the scanning is performed such that the light receiving position moves as shown in FIG. 20B, the light source 110 starts scanning from an angle that is most inclined in the +y direction and least included in the −x direction within preset angle ranges from the z axis, and the angle of the light beam is continuously changed from the most inclined angle in the +y direction toward the most inclined angle in the −y direction while maintaining the inclination in the −x direction without being changed. When the angle of the inclination in the −y direction reaches a maximum allowable value, the light source 110 increases the inclination of the light beam in the −x direction by a predetermined amount, and continuously changes the angle of the light beam from the most inclined angle in the −y direction toward the most inclined angle in the +y direction while maintaining the inclination in the −x direction. When the angle of the inclination in the +y direction reaches a maximum allowable value, the light source 110 again increases the inclination of the light beam in the −x direction by the predetermined amount. The operation described above is performed repeatedly. In the case where the light beam is emitted such that when emission directions are projected onto the light receiving surface of the image sensor 121, the resultant projected lines do not intersect or overlap, it is efficient to perform scanning at a high speed along the y direction in the above-described manner. The zigzag arrow in FIG. 20B indicates that the movement in the x direction is smaller than the movement in the y direction and thus the change in the angle of the light beam emission direction in the −x direction is smaller than the change in the angle in the y direction. The position of receiving the reflected light of the light beam may move in the +x direction by the small amount instead of moving in the −x direction. When the position of receiving the reflected light moves along the y direction, a plurality of light beams may be output simultaneously or consecutively at short time intervals in the high-speed scanning, it is possible to achieve high efficiency in the scanning.

In a case in which, unlike the example shown in FIG. 20B, the position of receiving the reflected light moves in the x direction from one end to the other end of the image sensor 121, then moves a shorter distance in the −y direction than the movement in the x direction, then moves in the x direction from the other end to the one end of the image sensor 121, and then moves the shorter distance in the −y direction than the movement in the x direction, wherein the operation described above is performed repeatedly. In this case, when the position of receiving the reflected light moves in the x direction, if a plurality of light beams are output at the same time or sequentially at short time intervals, projected lines of the plurality of light beams onto the light receiving surface overlap each other when y=0. Therefore, there is a possibility that in the same unit period, a plurality of pieces of reflected light originating from a plurality of light beams with different emission directions are incident on the same light receiving element. In contrast, in the case of the example shown in FIG. 20B, projected lines of a plurality of light beams with different emission directions onto the light receiving surface do not overlap each other. Therefore, in the configuration shown in FIG. 20A, it is efficient to perform scanning such that scanning in the y direction is performed at a high speed, and a plurality of pieces of reflected light originating from a plurality of light beams are received within the same unit period.

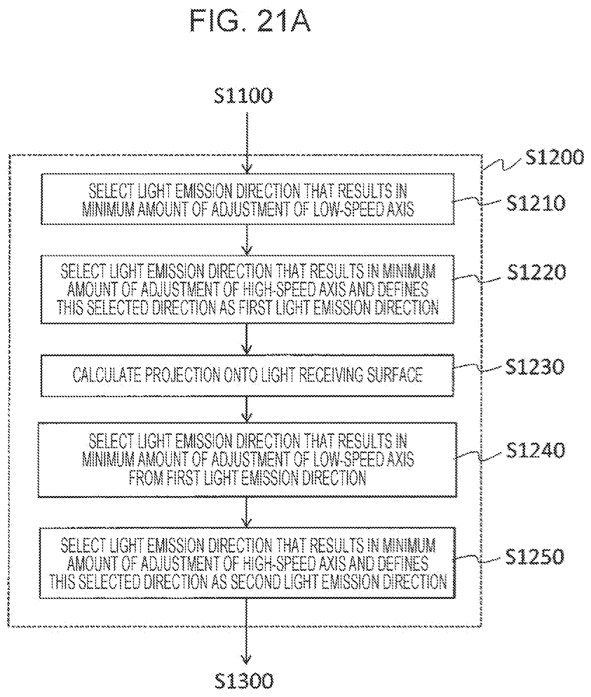

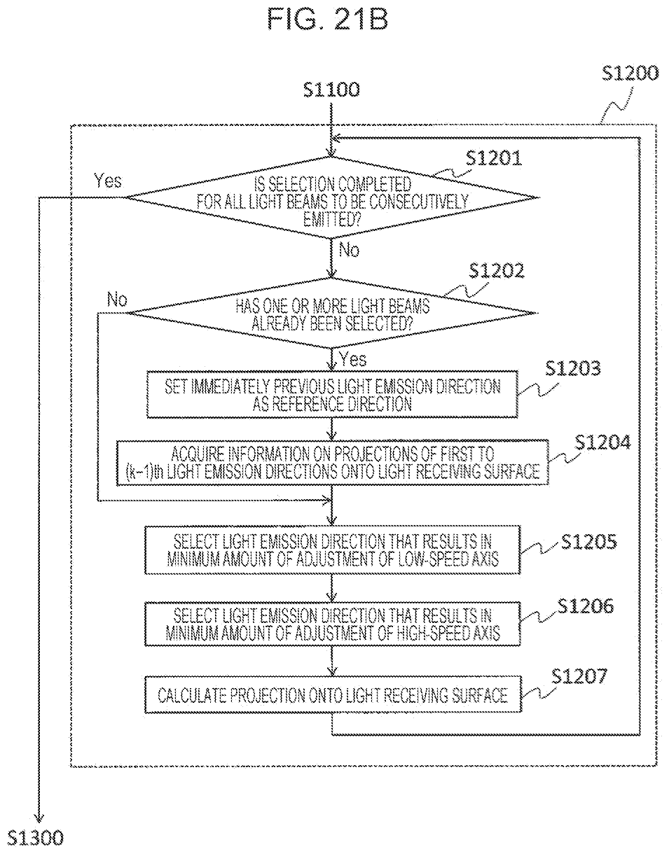

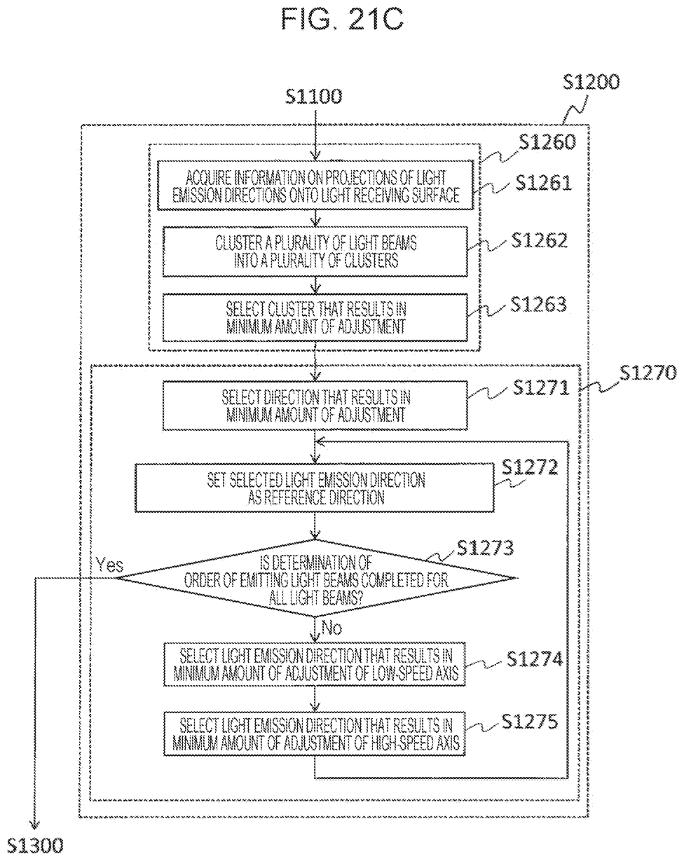

The process of determining light beams in step S1200 in FIG. 19 is described in detail below. FIG. 21A is a flowchart illustrating an example of a process of determining a combination of a plurality of light beams to be consecutively emitted in one unit period, and an order of emitting them. In this example, the light source 110 includes a MEMS mirror having a low speed axis and a high speed axis. The control circuit 130 executes the process including steps S1210 to S1250 shown in FIG. 21A. Each step of the operation is described below.

### Step S1210

The control circuit 130 selects, from all light beams which are to be emitted and which are stored in the memory 131, all light beams which are to be emitted with the smallest amount of adjustment about the low-speed axis but which have not yet been selected. The amount of adjustment about the low-speed axis is determined with reference to the direction of the immediately previously emitted light beam or with reference to a direction of the light beam specified in the initial setting. In a case where the tilt of a mirror is adjusted by controlling the rotation about two axes, as with a MEMS mirror, the rotation speed about one axis is generally slower than the rotation speed about the other axis. For example, in a case where the rotation speed about the y-axis is slower than the rotation speed about the x-axis, the y-axis direction is denoted as a low-speed axis direction and the x-axis direction is denoted as a high-speed axis direction.

### Step S1220

The control circuit 130 selects one light beam that needs the smallest amount of adjustment about the high-speed axis from the light beams selected in step S1210. The amount of adjustment about the high-speed axis is also determined with reference to the direction of the immediately previously emitted light beam or the direction of the light beam specified in the initial setting. The emission direction of the selected light beam is set as a first light emission direction.

### Step S1230

The control circuit 130 calculates a straight line obtained when the direction of the light beam selected in step S1220 is projected onto the light receiving surface of the image sensor 121, and stores the information on the calculation result in the memory 131.

### Step S1240

The control circuit 130 selects, from all light beams which are to be emitted and which are stored in the memory 131, all light beams which need the smallest amount of adjustment from the first light emission direction about the low-speed axis and which have not yet been selected. However, when a direction of a light beam is projected onto the light receiving surface of the image sensor 121, if the resultant projected line overlaps or intersects the straight line calculated in step S1230, any such light beam is excluded.

### Step S1250

The control circuit 130 selects, from the light beams selected in step S1140, one light beam that needs the smallest amount of adjustment about the high-speed axis from the first light emission direction. The emission direction of the selected light beam is set as a second light emission direction.

Thus, via the process described above, the emission direction of the first light beam and the emission direction of the second light beam that are to be consecutively emitted in one unit period are determined.

In the present embodiment, the light source 110 consecutively emits light beams in two directions, but may emit three or more light beams. Also in this case, the combination of the emission directions of the light beams may be selected in a similar manner as described above. An example is described below for a case in which three or more light beams are emitted in each unit period.

FIG. 21B is a flowchart showing an example of a method for determining light beams for a case where three or more light beams are consecutively emitted in different directions. Here, let n denote the number of light beams emitted consecutively where n is an integer equal to or larger than 3. The control circuit 130 executes a process including steps S1201 to S1207 shown in FIG. 21B. Each step of the operation is described below.

### Step S1201

The control circuit 130 determines whether or not the n light beams to be emitted consecutively are all selected. In a case where all light beams have already been selected, the process proceed to step S1300. In a case where there is a beam which has not yet been selected, the process proceed to step S1202.

### Step S1202

The control circuit 130 determines whether or not one or more light beams have already been selected out of the n light beams to be selected. In a case where no light beam has been selected yet, the process proceed to step S1205. In a case where one or more light beams have already been selected, the process proceeds to step S1203.

### Step S1203

The control circuit 130 sets an immediately previously determined light emission direction of a light beam as a reference direction in the adjustment. That is, when a k-th light beam (k is an integer equal to or larger than 2) is selected from the n light beams, the light emission direction of a (k−1)th light beam is set as the reference direction.

### Step S1204

The control circuit 130 acquires, from the memory 131, information on straight lines obtained when the directions of the first to (k−1)th light beams are respectively projected onto the light receiving surface of the image sensor 121.

### Step S1205

The control circuit 130 selects all light beams which need the smallest amount of adjustment about the low-speed axis from light beams that have not yet been selected among all light beams to be emitted specified in the memory 131. However, when a direction of a light beam is projected onto the light receiving surface of the image sensor 121, if the resultant projected line overlaps or intersects the straight line obtained in step S1204, any such light beam is excluded. Note that the amount of adjustment about the low-speed axis is determined with reference to the direction of the immediately previously selected light beam or with reference to a direction of the light beam specified in the initial setting. When a second or subsequent light beam is selected, the direction of the light beam set in step S1203 as the reference direction is used as the reference direction.

### Step S1206

The control circuit 130 selects one light beam that needs the smallest amount of adjustment about the high-speed axis from the light beams selected in step S1205. The amount of adjustment about the high-speed axis is also determined with reference to the direction of the immediately previously selected light beam or the direction of the light beam specified in the initial setting.

### Step S1207

The control circuit 130 calculates a straight line that is obtained when the direction of the light beam is projected onto the light receiving surface of the image sensor 121, based on the direction of the light beam selected in step S1206, and stores the result in the memory 131.

By repeatedly performing the process described above, the control circuit 130 can sequentially select n light beams to be consecutively emitted.

In the examples shown in FIGS. 21A and 21B, the selection of the light beams and the determination of the order of emitting them are performed at the same time. However, they may be performed separately. For example, directions of a plurality of light beams to be consecutively emitted may be selected first, and then the order of emitting the selected plurality of light emission directions may be determined. An example of such a process is described below with reference to FIG. 21C.

FIG. 21C is a flowchart illustrating another example of a process in step S1200 shown in FIG. 19. In this example, step S1200 includes step S1260 for selecting directions of n light beams to be emitted consecutively and step S1270 for determining the order of emitting the light beams. Step S1260 includes steps S1261 to S1263, and step S1270 includes steps S1271 to S1275. Each step of the operation is described below.

### Step S1261

The control circuit 130 calculates a straight line obtained when a direction of a light beam is projected onto light receiving surface of the image sensor, for each of all emission directions of light beams which are not emitted yet. Alternatively, in a case where the straight lines are pre-calculated and stored, the information about them is acquired.

### Step S1262

The control circuit 130 clusters all not-yet-emitted light beams into lusters each including n light beams according to criteria described below. The n light beams included in each cluster should satisfy the condition that when the emission directions of the n light beams are projected onto the light receiving surface of the image sensor 121, the resultant projected lines do not overlap and do not intersect with each other in the light receiving surface. The n light beams included in each cluster also should satisfy the condition that the emission directions thereof are close to each other, that is, a small amount of adjustment is needed to change the emission direction from one light beam to another in the cluster. In a case where the light source 110 used is realized by a beam scanner having a low-speed axis and a high-speed axis for adjusting the beam emission direction, weighting may be performed according to the adjustment speed for each axis in the calculation of the amount of adjustment. For example, in the calculation of the amount of adjustment between emission directions of light beams, weighting factors of 5 and 1 may be respectively applied to the low-speed axis and the high speed axis. The clustering may be performed such that the sum of the amounts of adjustments is minimized in each cluster.

### Step S1263

For each of all clusters generated in step S1262, the control circuit 130 selects, from light emission directions in the cluster, a light emission direction that needs a minimum amount of adjustment. The amount of adjustment is determined with reference to the direction of the immediately previously emitted light beam or with reference to a direction of the light beam specified in the initial setting. The control circuit 130 selects a cluster which includes a light beam for which the amount of adjustment of the light emission direction is the smallest among the selected emission directions with the smallest amounts of adjustments in the respective clusters. The n light beams included in the selected cluster are selected as n light beams that are to be consecutively emitted.

### Step S1271

The control circuit 130 selects a light beam that needs the smallest amount of adjustment of the emission direction from the n light beams included in the cluster selected in step S1263. The amount of adjustment is determined with reference to the direction of the immediately previously emitted light beam or with reference to a direction of the light beam specified in the initial setting. The light beam selected here is to be emitted first of the n light beams.

### Step S1272

The control circuit 130 sets the light emission direction selected in step S1271 as the reference direction.

### Step S1273

The control circuit 130 determines whether or not the order of emitting light beams has been determined for all the n light beams to be consecutively emitted. In a case where the light emission order has been determined for all the n light beams, the process proceeds to step S1300. In a case where the light emission order has not yet been determined for of the n light beams, the process proceeds to step S1274.

### Step S1274

The control circuit 130 selects, from light emission directions which are included in the cluster selected in step S1263 but whose light emission order is not yet determined, all light emission directions that need the smallest amount of adjustment of the emission direction from the reference direction about the low-speed axis.

### Step S1275

The control circuit 130 selects, from the light emission directions selected in step S1274, one light emission direction that needs the smallest amount of adjustment of the light emission direction from the reference direction about the high-speed axis. The light beam with the light emission direction selected here is to be emitted next. After step S1275, the process returns to step S1272.

By repeatedly performing the process from step S1272 to step S1275, it is possible to determine the order of emitting n light beams to be consecutively emitted.

### 1-2-2 Charge Measurement by Light Emission and Exposure Operation

Next, the details of the process in step S1300 including the process performed by the light source 110 to emit light and the exposure operation performed by the light receiving device 120.

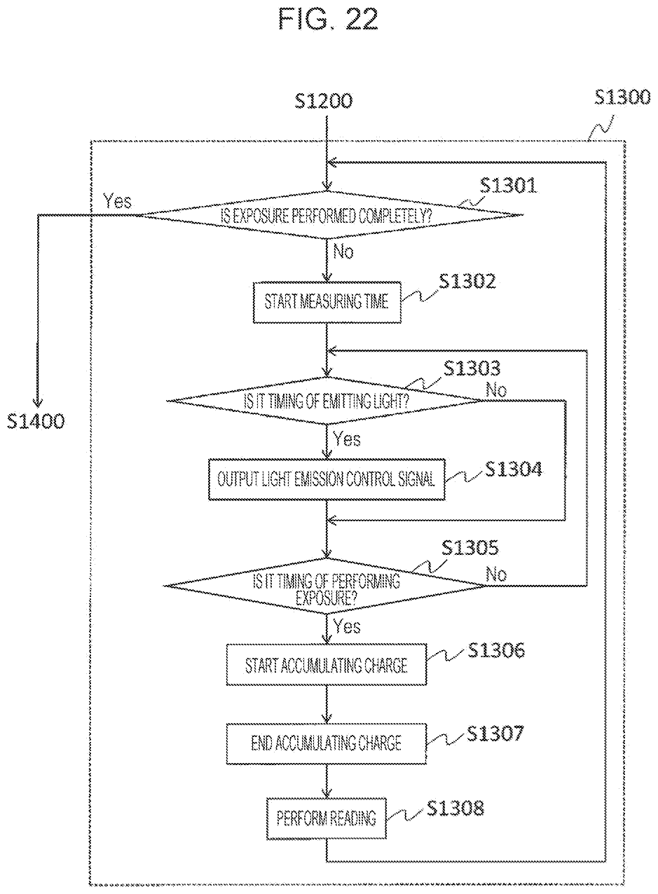

FIG. 22 is a flowchart illustrating the details of the process in step S1300. Here, the process is described by way of example for a case where the control is performed as shown in FIG. 7B. The control circuit 130 executes a process including steps S1301 to S1308 shown in FIG. 22. Each step of the operation is described below.

### Step S1301

The control circuit 130 determines whether the exposure operation has been performed as many times as the preset number of times. If the decision here is Yes, the process proceeds to step S1400, but the decision is No, the process proceeds to step S1302.

### Step S1302

The control circuit 130 starts measuring time.

### Step S1303

The control circuit 130 determines whether or not the present time is the timing of emitting a light beam based on the light beam emission order determined in step S1200 and the length of time for adjustment of the light beam emission direction depending on the light beam emission order, the predetermined length of the pulse of each light beam, and the time length of each exposure period. In a case where it is determined that the present time is the light emission timing, the process proceeds to step S1304. However, in a case where it is determined that the present time is not light emission timing, the process proceeds to step S1305.

### Step S1304

The control circuit 130 sends a light emission control signal to the light source 110. The light source 110 emits a first light beam or a second light beam in a specified direction according to the light emission control signal. The light emission control signal includes information on the beam shape, the spread angle, the emission direction, and the pulse time length for each light beam. The information on the beam shape, the spread angle, and the emission direction is, for example, information such as that shown in FIG. 4, and is stored in the memory 131. The pulse time length of each light beam is set to an appropriate value in advance.

### Step S1305

The control circuit 130 determines whether or not the present time is the timing of performing an exposure operation based on the exposure timing determined according to the time for the adjustment of the emission direction of the light beam depending on the light beam emission order determined in step S1200, and based on the predetermined exposure time length. In a case where it is determined that the present time is the timing of performing the exposure operation, the process proceeds to step S1306. However, in a case where it is determined that the present time is not the timing of performing the exposure operation, the process returns to step S1303.

### Step S1306

The control circuit 130 outputs an exposure start signal. In response to the exposure start signal, the light receiving device 120 starts the exposure operation.

### Step S1307

When the predetermined exposure time length elapses after step S1306, the control circuit 130 outputs an exposure end signal. In response to the exposure end signal, the light receiving device 120 ends the exposure operation.

### Step S1308

The control circuit 130 controls the light receiving device 120 to read a signal indicating the amount of charge accumulated in each pixel. The read signal is sent to the signal processing circuit 140. After the end of step S1308, the process returns to step S1301.

By repeating the process in steps S1301 to S1308, the control shown in FIG. 7B is realized. As a result, the charge accumulated in each pixel via the exposure operation is measured for each exposure period.

### 1-2-3 CALCULATION OF DISTANCE

Next, the details of the process of calculating the distance for each pixel in step S1400 is described.

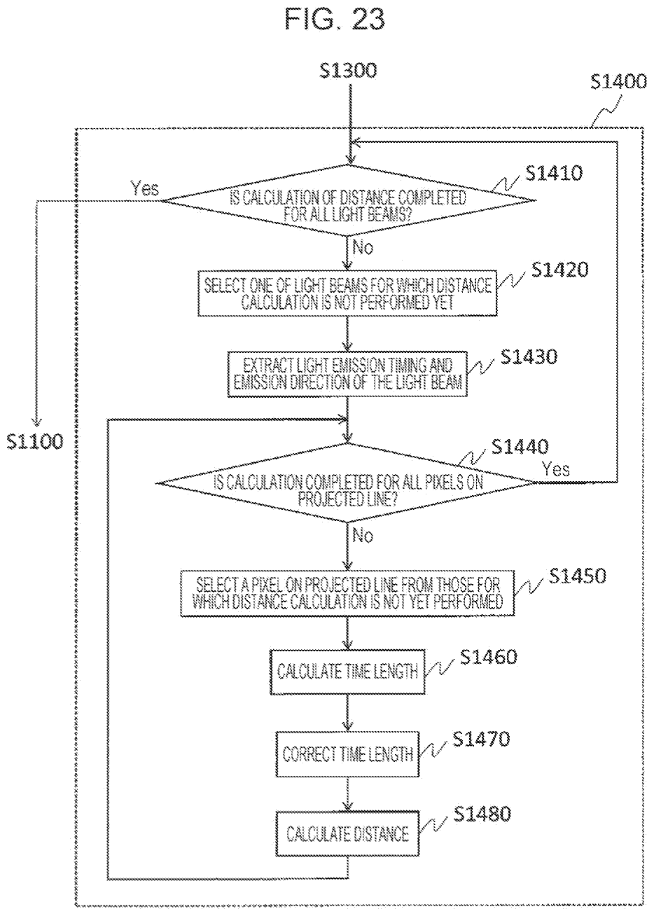

FIG. 23 is a diagram showing an example of a distance calculation process executed by the signal processing circuit 140. The signal processing circuit 140 executes a process including steps S1410 to S1480 shown in FIG. 23. Each step of the operation is described below.

### Step S1410

The signal processing circuit 140 determines whether or not the distance calculation is completed for all the light beams consecutively emitted in each unit period. In a case where the distance calculation is completed for all the light beams emitted consecutively, the process returns to step S1100 and starts the process for a next unit period. In a case where the distance calculation is not yet completed for all the light beams emitted consecutively, the process proceeds to step S1420.

### Step S1420

The signal processing circuit 140 selects one light beam for which the distance calculation is not yet performed from the consecutively emitted light beams.

### Step S1430

The signal processing circuit 140 extracts information on the light emission timing and the light emission direction of the selected light beam based on the light emission control signal acquired from the control circuit 130. The light emission timing refers to the relative time from the start of the emission of the first light beam of the plurality of consecutively emitted light beams. Furthermore, the signal processing circuit 140 detects a plurality of pixels located on a straight line obtained by projecting the direction of the selected light beam onto the light receiving surface of the image sensor 121.

### Step S1440

The signal processing circuit 140 determines whether or not the distance calculation is completed for all the pixels on the projected line detected in step S1430. In a case where the distance calculation is completed for all the pixels on the projected line, the process returns to step S1410. However, in a case where the distance calculation is not yet completed for all the pixels on the projected line, the process proceeds to step S1450.

### Step S1450

The signal processing circuit 140 select one pixel for which the distance calculations is not yet performed from the plurality of pixels on the projected line.

### Step S1460

The signal processing circuit 140 determines the time length, for the pixel selected in step S1450, from the start of the emission of the first light beam of the plurality of consecutive emitted light beams to the reception of light by the method described above with reference to FIG. 6A based on the relative amounts of charges accumulated in the consecutive exposure periods.

### Step S1470

The signal processing circuit 140 corrects the time length determined in step S1460 for the pixel of interest by using the information on the light emission timing of the light beam acquired in step S1430. The correction is performed, for example, by subtracting the time length from the start of the emission of the first light beam to the start of the emission of the light beam of interest from the time length from the start of the emission of the first light beam of the plurality of consecutively emitted light beams to the reception of light. Thus, the time length from the start of the emission of the light beam of interest to the reception of light is obtained.

### Step S1480

The signal processing circuit 140 calculates the distance based on the corrected time length obtained in step S1470 by the method described above with reference to FIG. 6A. After the end of step S1480, the process returns to step S1440.

By repeating the process in steps S1410 to S1480, it is possible to calculate the distances to a plurality of objects located in the directions of the plurality of consecutively emitted light beams.

### 1-3 Effects

As described above, the distance measurement apparatus 100 according to the present embodiment includes the light source 110, the light receiving device 120 including the plurality of light receiving elements, the control circuit 130, and the signal processing circuit 140. The control circuit 130 controls the light source 110 to sequentially emit a plurality of light beams toward a scene in the predetermined unit period such that irradiation regions do not overlap. The control circuit 130 perform control such that a plurality of pieces of reflected light from the scene originating from the plurality of light beams are received by part of the plurality of light receiving elements in the same exposure period, and light reception data is output. The signal processing circuit 140 generates distance data at locations of the part of the plurality of light receiving elements based on the light reception data, and outputs the resultant distance data. Here, the control circuit 130 determines the combination of directions of a plurality of light beams such that a plurality of pieces of reflected light originating from the plurality of light beams are respectively incident on different light receiving elements of the plurality of light receiving elements. More specifically, the plurality of light receiving elements are two-dimensionally arranged along the light receiving surface of the light receiving device, and the control circuit 130 determines the combination of the directions of the plurality of light beams such that the paths of the plurality of light beams projected onto the light receiving surface do not overlap or intersect with each other on the light receiving surface. The control circuit 130 executes the above-described process in each of a plurality of consecutive unit periods. However, the combination of the directions of the plurality of light beams is determined such that the combination is different for each unit period.

Thus, the distance can be measured for the entire scene in a short time as compared with the conventional distance measuring system in which a light beam is emitted in only one direction in each unit period. Therefore, even when the distance measurement is performed for a large target area, the distance measurement can be performed in a practically short time. For example, in a case where a distance image is generated in the form of a moving image, it is possible to achieve smooth movement at a high frame rate. By increasing the frame rate, it is possible to improve the accuracy of the distance image by using the information on the time. Furthermore, it is possible to prevent a plurality of pieces of reflected light from a plurality of objects existing at different positions from being incident on the same light receiving element, which makes it possible to achieve higher accuracy in the distance measurement.

In the present embodiment, the number of light beams emitted sequentially in each unit period is two. However, three or more light beams may be emitted. In a case where the distance measurement is performed using the method shown in FIG. 7A or FIG. 7B, the number of exposure periods included in each unit period is set to be one more than the number of light beams emitted sequentially. Modification of first embodiment

Next, a modification of the first embodiment is described below. In the first embodiment, the indirect ToF method is used in measuring the distance from the distance measurement apparatus 100 to an object. However, in this modification, a direct ToF method is used

In the first embodiment, the light receiving device 120 of the distance measurement apparatus 100 is the image sensor in which the plurality of light receiving elements are arranged two-dimensionally along the light receiving surface. In contrast, in this modification, the light receiving device 120 is a sensor in which light receiving elements each accompanied with a timer counter are arranged two-dimensionally along the light receiving surface. The timer counter starts measuring the time when an exposure operation stats, and ends the measuring the time when reflected light is received by a light receiving element. In this way, the timer counter measures the time for each light receiving element and directly measures the flight time of light.

Note that the basic configuration of the present modification similar to that shown in FIG. 1 or 3. However, the present modification is different from the first embodiment in the configuration of the light receiving device 120 and in the process performed by the control circuit 130 and the signal processing circuit 140. The present modification is described below while focusing on the differences from the first embodiment.

In the present modification, the light receiving device 120 is a sensor device in which each light receiving element have an own timer counter. By using the timer counter, it is possible to measure the elapsed time from the start of an exposure operation to the reception of light for each light receiving element. Each light receiving element outputs time data indicating a result of the measurement by the timer counter as “light reception data”.

In the present modification, the signal processing circuit 140 calculates the distance for each pixel based on time values associated with each pixel output by the light receiving device 120 in each exposure period. The signal processing circuit 140 can generate and output a distance image based on the calculated distance values for the respective pixels.

Also in the present modification, the distance measurement apparatus performs the process shown in FIG. 19. However, steps S1300 and S1400 are modified as described below.

### Step S1300

The control circuit 130 outputs light emission control signals for a plurality of light beams to the light source 110. At the same time, the control circuit 130 outputs, to the signal processing circuit 140, information on straight lines on the sensor plane obtained by projecting the light emission direction onto the sensor plane and information on the exposure timing. Furthermore, the control circuit 130 outputs control signals for starting and ending an exposure operation to the light receiving device 120. Each light receiving element of the light receiving device 120 starts the operation of the corresponding timer counter at the same time as the start of the exposure operation. Each light receiving element stops the timer counter when reflected light is received, and measures the elapsed time from the start of the exposure operation to the light reception.

### Step S1400

The signal processing circuit 140 corrects the value of the elapsed time associated with each light receiving element measured in step S1300 by using the value of the emission timing of each light beam, and calculates the distance for each light receiving element.

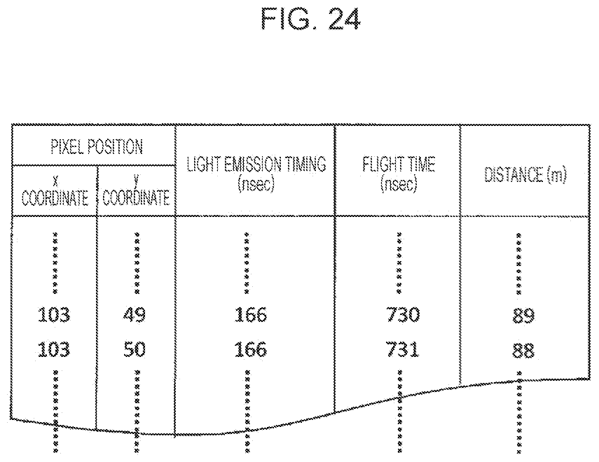

FIG. 24 shows an example of data stored in the memory 141 of the signal processing circuit 140 according to the present modification. In the present modification, the memory 141 stores the information shown in FIG. 24 instead of the information shown in FIG. 18. The information stored in the memory 141 includes xy coordinate values indicating the positions of the respective light receiving elements on the light receiving surface of the light receiving device 120, light emission timing of light beams whose reflected light may be incident on positions indicated by the xy coordinate values, the values of the measured flight times, and the calculated distance values. Note that the light emission timing of a light beam is given by a time as measured from the start of emission of a first light beam of a plurality of light beams that are consecutively emitted.

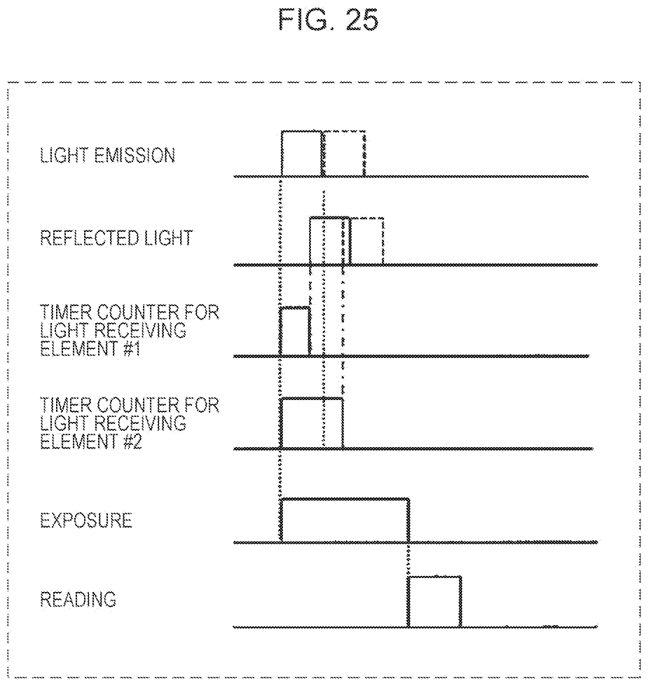

FIG. 25 is a schematic diagram showing an example of light emission timing, arrival timing of reflected light, timing of each of two timer counters, exposure timing, and signal reading timing in the present modification. In this example, the light emission timing and the reflected light reception timing are the same as those shown in the example in FIG. 7A. In the present modification, the exposure operation is performed only once in each unit period. In this exposure period, two pieces of reflected light caused by two light beams emitted in different directions are detected by two different light receiving elements or light receiving element groups. Each light receiving element starts measuring time by a corresponding timer counter when a first light beam is emitted stops the timer counter when reflected light is detected, and generates data regarding the time between the start and the end of the timer counter as light reception data. When a predetermined time elapses from the emission of a second light beam, the control circuit 130 stops the exposure operation and instructs the light receiving device 120 to read the light reception data. In this reading period, the light reception data is read from a light receiving element that detected the reflected light. When a light receiving element does not detect reflected light in the exposure period, the light receiving element stops its timer counter at the end of the exposure period without storing time data.

In the example shown in FIG. 25, a light receiving element #1 receives reflected light originating from the light beam emitted first, and the timer counter associated therewith measures the elapsed time from the start of the light emission to the start of the light reception. Therefore, the measured value is directly stored as the flight time. In contrast, the light receiving element #2 receives reflected light originating from the second light beam emitted following the first light beam, and the timer counter associated therewith measures the elapsed time from the start of the emission of the first light beam to the start of the reception of the reflected light originating from the second light beam. Therefore, the signal processing circuit 140 calculates the flight time by subtracting, from the measured time, the time corresponding to the difference between the start of the emission of the first light beam and the start of the emission of the second light beam. The difference in the emission start timing between the two light beams can be obtained by referring to values of the light emission timing shown in FIG. 24.

As described above, in the present modification, the control circuit 130 controls each of the plurality of light receiving elements to perform an exposure operation in one exposure period included in each unit period thereby allowing reflected light to be received by part of the plurality of light receiving elements. Based on the time from when each of the plurality of light beams is emitted until reflected light generated by the light beams is received by one of the plurality of light receiving elements, the signal processing circuit 140 generates distance data at the position of the light receiving element by which the reflected light is received. Via the process described above, it is possible to obtain similar effects to those obtained in the first embodiment.

### Second Embodiment

Next, a distance measurement apparatus according to a second embodiment is described below. In the first embodiment described above, the distance measurement apparatus includes the single light source 110 that sequentially emits a plurality of light beams in different directions. In contrast, in the second embodiment, the distance measurement apparatus includes a plurality of light sources that simultaneously emit light beams to a scene to be measured. A configuration and an operation of the distance measurement apparatus according to the second embodiment are described below while focusing on differences from the first embodiment.

### 2-1 Configuration of Distance Measurement Apparatus

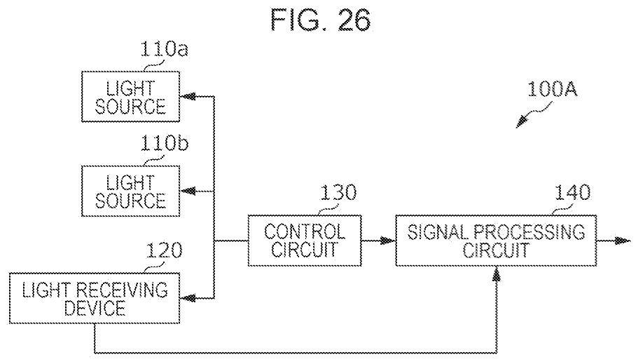

FIG. 26 is a block diagram illustrating a basic configuration of the distance measurement apparatus 100A according to the second embodiment. The configuration shown in FIG. 26 is the same as the configuration shown in FIG. 1 except that the light source 110 is replaced by light sources 110a and 110b.

The light sources 110a and 110b each may be a light emitting device capable of emitting a light beam such as a laser beam in an arbitrary direction. The light sources 110a and 110b are equal in specifications in terms of the spread angle and intensity of the light beam, and the like. Regarding the configuration as a single light source, each of the light sources 110a and 110b have the same configuration as the light source 110 according to the first embodiment. The configurations of a light receiving device 120, a control circuit 130, and a signal processing circuit 140 are the same as the corresponding configurations according to the first embodiment.

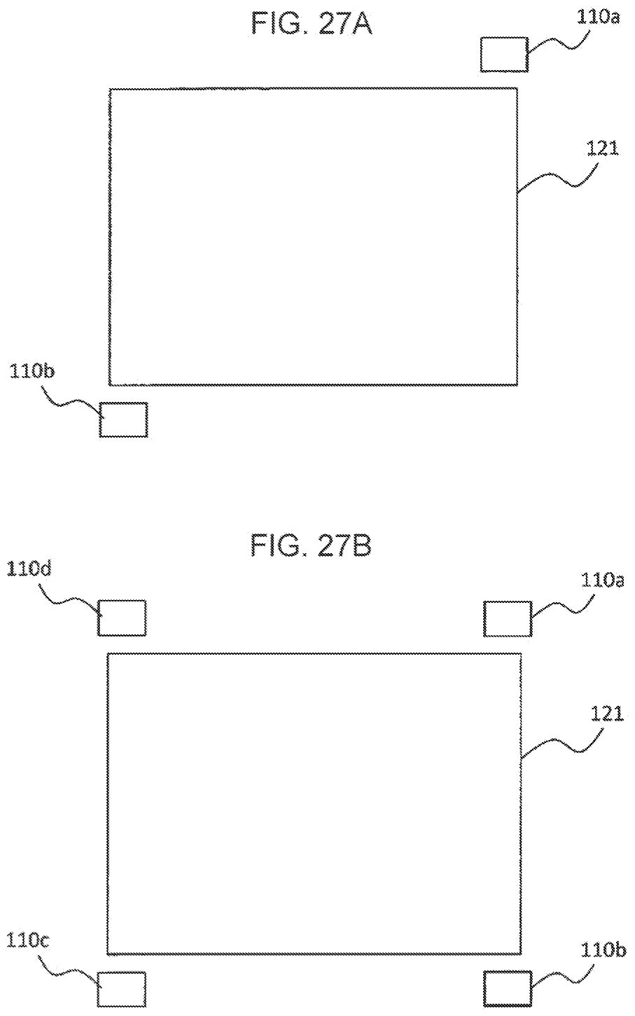

FIG. 27A is a diagram schematically illustrating an example of arrangement of the light sources 110a and 110b in the present embodiment. In this example, the light sources 110a and 110b are disposed at locations symmetrical with respect to the center of the light receiving surface of the image sensor 121 of the light receiving device 120. The light sources 110a and 110b are equidistant from the center of the light receiving surface of the image sensor 121 of the light receiving device 120. By employing such a configuration, it is possible to achieve equal parallax between a light source and the image sensor 121 for both light sources 110a and 110b. This makes it possible to reduce an error of the distance calculation.

The number of light sources is not limited to two, but three or more light sources may be used. FIG. 27B illustrates another example in which four light sources 110a, 110b, 110c, and 110d are disposed. Also in this case, the four light sources may be arranged symmetrically with respect to the center of the light receiving surface of the image sensor 121.

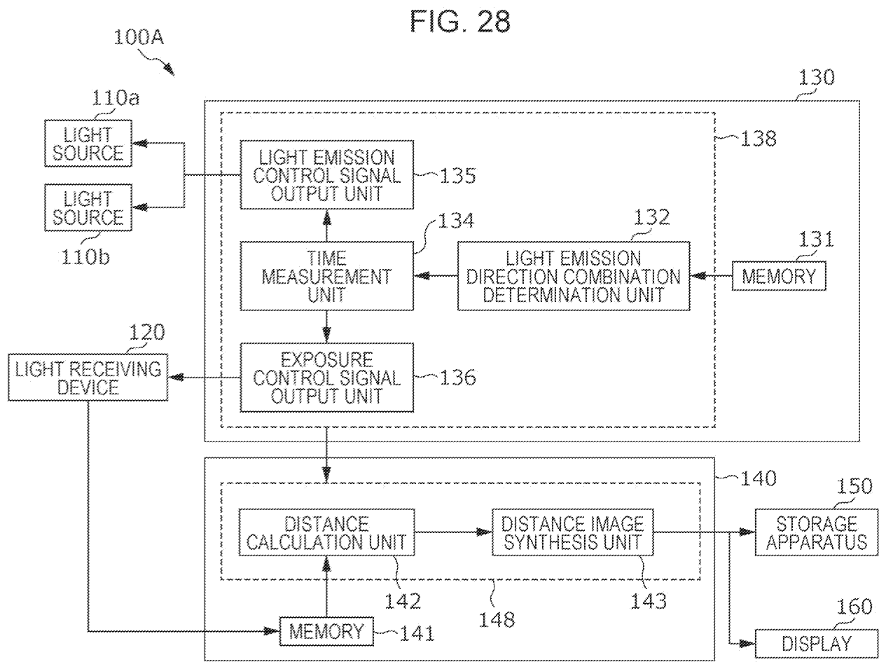

FIG. 28 is a block diagram illustrating an example of a further-detailed configuration of the distance measurement apparatus 100A according to the present embodiment. This configuration is different from the configuration shown in FIG. 3 only in that the light source 110 is replaced by two light sources 110a and 110b.

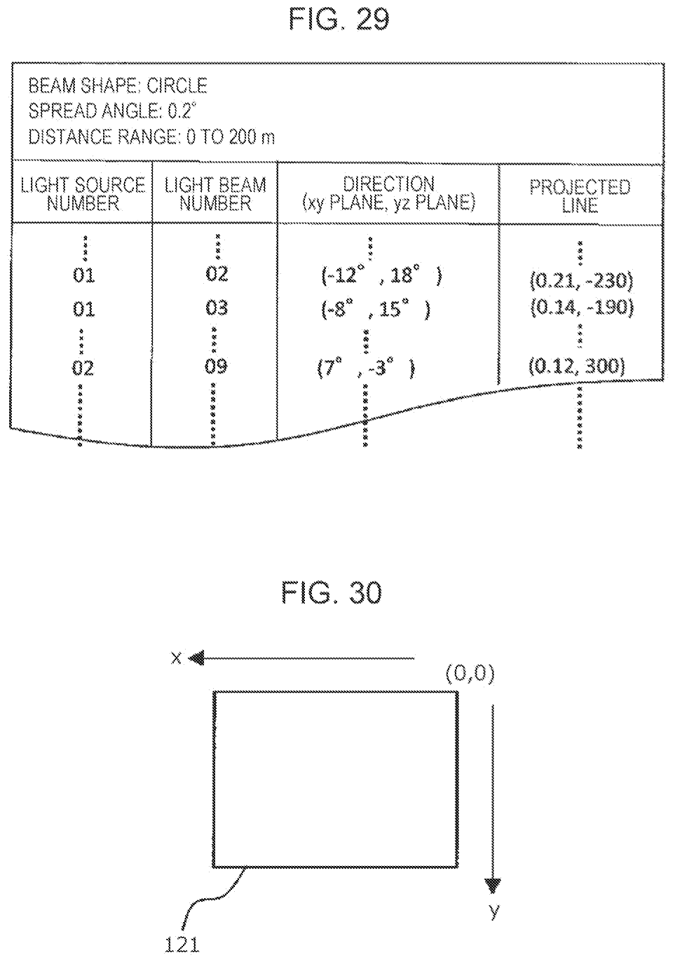

FIG. 29 is a diagram illustrating an example of information stored in a memory 131 according to the present embodiment. FIG. 30 is a diagram showing a coordinate system of an image sensor plane defined in the present embodiment. In this example, information stored in the memory 131 includes the light source number, the light beam number, the light beam emission direction, and the information on the straight line that is obtained when the light beam emission direction is projected onto the light receiving surface of the image sensor 121. The information on the projected line may be information describing the slope and the intercept of the projected line represented by the coordinate system of the image sensor plane shown in FIG. 30. As in the first embodiment, information on the shape, the spread angle, and the reach range of each light beam is also stored as information common to the plurality of light beams.

The control circuit 130 determines a combination of light beams to be emitted simultaneously or consecutively in each unit period by selecting such light beams from those which are stored in the memory 131 but which are not yet emitted from selected from those which are stored in the memory 131 but which are not yet emitted, and determines the timing of emitting each of the light beams and the order of emitting them. Also in the present embodiment, the distance measurement apparatus 100A uses the indirect ToF method in the distance measurement. The distance measurement method and the distance calculation method by indirect ToF are the same as those in the first embodiment.

### 2-2 Operation of Distance Measurement Apparatus

Next, an operation of the distance measurement apparatus 100A according to the present embodiment is described below. The basic operation of the distance measurement apparatus 100A is similar to the operation shown in FIG. 19, although there is differences in the operation in steps S1200 and S1300 as described below.

### Step S1200

In the present embodiment, a plurality of light sources are provided, and thus as many light beams can be emitted simultaneously as the number of light sources. Therefore, the control circuit 130 controls each light source such that simultaneous light emission by the light source 110a and the light source 110b is performed consecutively a plurality of times. In both the case in which the light beams are emitted simultaneously and the case in which the light beams are sequentially emitted, the combination of light beams emitted in the same unit period is determined in a similar manner to the first embodiment. That is, the combination of directions of light beams is determined such that a plurality of pieces of reflected light originating from the plurality of emitted light beams are incident on respective different points on the light receiving surface of the image sensor 121 regardless of positions of objects in a scene. That is, the plurality of pieces of reflected light originating from the light beams emitted in the same unit period are received by different light receiving elements on the light receiving surface of the image sensor 121. The order of emitting the light beams are determined so as to minimize the time required to switch the light emission directions as in the first embodiment. In the present embodiment, a plurality of light sources are provided, and thus the control circuit 130 may determine the order of emitting light beams such that the times of switching the light beam emission directions are equal for the plurality of light sources. This makes it possible to easily control the exposure timing so as to correctly correspond to the light emission timing thereby making is possible to execute the light emission and the exposure operation in an efficient manner without having a waiting time due to a difference in timing of switching the directions between the light sources.

### Step S1300

The control circuit 130 instructs the respective light sources 110a and 110b to emit light according to the determined order and light emission timing. The control circuit 130 outputs a light emission control signal to each of the light sources 110a and 110b. In the present embodiment, each of the light sources 110a and 110b consecutively emits two light beams in different directions in one unit period. Reflected light generated by the emitted light is detected by part of the light receiving elements of the light receiving device 120. The exposure operation of each light receiving element is controlled in a similar manner to the first embodiment.

### 2-2-1 Determining the Combination of Light Emission Directions and the Order of Emitting Light Beams

Next, a specific example of the process in step S1200 according to the present embodiment is described below.

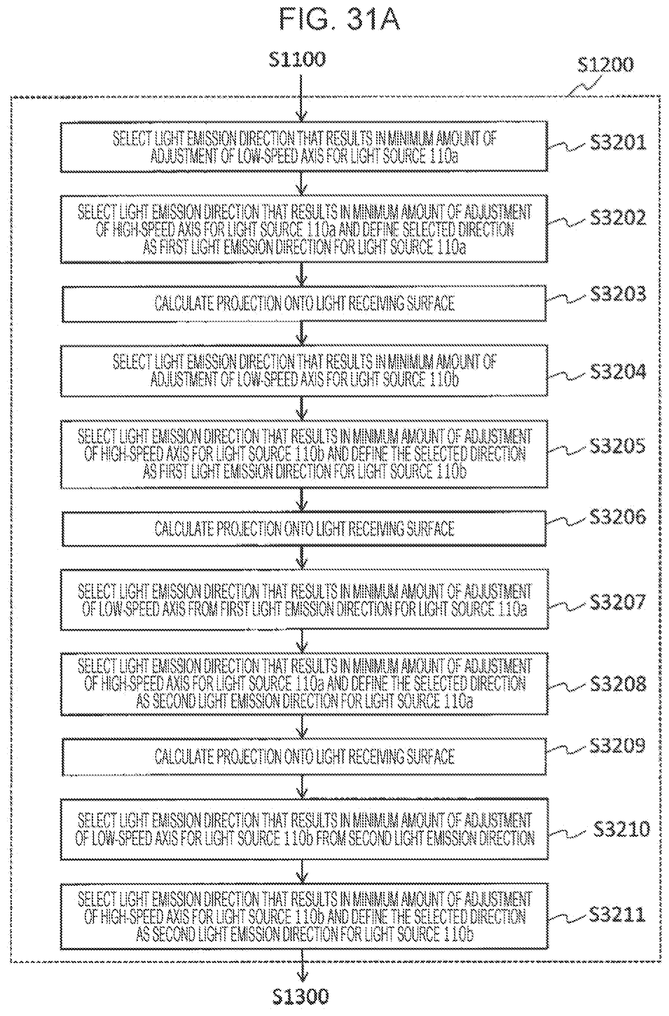

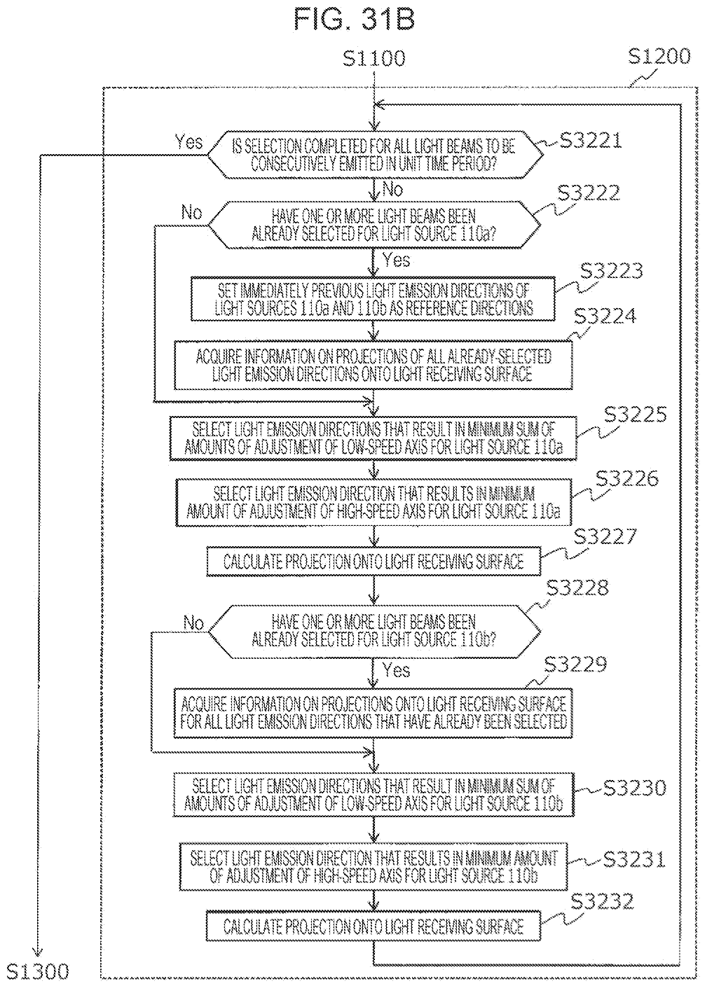

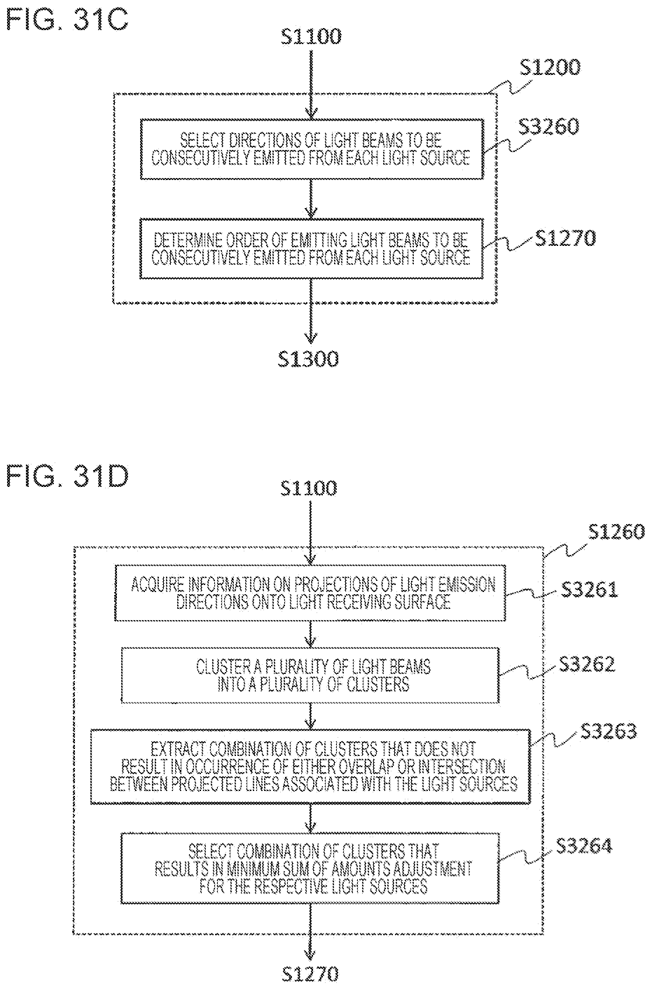

FIG. 31A is a flowchart illustrating an example of a process of determining a combination of a plurality of light beams to be consecutively emitted in one unit period simultaneously from the light sources 110a and 110b, and determining the order of emitting the light beams. In this example, the light source 110a and 110b each include a MEMS mirror having a low speed axis and a high speed axis. The control circuit 130 executes a process including steps S3201 to S3211 shown in FIG. 31A. Each step of the operation is described below.

### Step S3201

The control circuit 130 selects, from light beams which are stored in the memory 131 and which are to be emitted from the light source 110a but which are not yet emitted, all light beams which need the smallest amount of adjustment about the low-speed axis from light beams. The amount of adjustment about the low-speed axis is determined with reference to the direction of the light beam immediately previously emitted from the light source 110a or with reference to a direction of the light beam specified in the initial setting.

### Step S3202

The control circuit 130 selects one light beam that needs the smallest amount of adjustment about the high-speed axis from the light beams selected in step S3201. The amount of adjustment about the high-speed axis is also determined with reference to the direction of the light beam immediately previously emitted from the light source 110a or the direction of the light beam specified in the initial setting. The emission direction of the selected light beam is set as a first light emission direction of the light source 110a.

### Step S3203

The control circuit 130 calculates a straight line obtained when the direction of the light beam selected in step S3202 is projected onto the light receiving surface of the image sensor 121, and stores the information on the calculation result in the memory 131.

### Step S3204

The control circuit 130 selects all light beams which need the smallest amount of adjustment about the low-speed axis from light beams which are stored in the memory 131 and which are to be emitted from the light source 110b but which have not yet been emitted. The amount of adjustment about the low-speed axis is determined with reference to the direction of the light beam immediately previously emitted from the light source 110b or with reference to a direction of the light beam specified in the initial setting. However, when a direction of a light beam is projected onto the light receiving surface of the image sensor 121, if the resultant projected line overlaps or intersects the straight line calculated in step S3203, any such light beam is excluded.

### Step S3205

The control circuit 130 selects one light beam that needs the smallest amount of adjustment about the high-speed axis from the light beams selected in step S3204. The amount of adjustment about the high-speed axis is also determined with reference to the direction of the light beam immediately previously emitted from the light source 110b or with reference to the direction of the light beam specified in the initial setting. The emission direction of the selected light beam is set as a first light emission direction of the light source 110b.

### Step S3206

The control circuit 130 calculates a straight line obtained when the direction of the light beam selected in step S3205 is projected onto the light receiving surface of the image sensor 121, and stores the information on the calculation result in the memory 131.

### Step S3207

The control circuit 130 selects all light beams which need the smallest amount of adjustment from the first light emission direction of the light source 110a about the low-speed axis from light beams which are stored in the memory 131 and which are to be emitted from the first light source 110a but which have not yet been selected. However, when a direction of a light beam is projected onto the light receiving surface of the image sensor 121, if the resultant projected line overlaps or intersects the straight line calculated in step S3203 or S3206, any such light beam is excluded.

### Step S3208

The control circuit 130 selects, from the light beams selected in step S3207, one light beam that needs the smallest amount of adjustment about the high-speed axis from the first light emission direction for the light source 110a. The emission direction of the selected light beam is set as a second light emission direction for the light source 110a.

### Step S3209

The control circuit 130 calculates a straight line obtained when the direction of the light beam selected in step S3208 is projected onto the light receiving surface of the image sensor 121, and stores the information on the calculation result in the memory 131.

### Step S3210

The control circuit 130 selects all light beams which need the smallest amount of adjustment from the first light emission direction of the light source 110b about the low-speed axis from light beams which are stored in the memory 131 and which are to be emitted from the light source 110b but which have not yet been selected. However, when a direction of a light beam is projected onto the light receiving surface of the image sensor 121, if the resultant projected line overlaps or intersects the straight line calculated in step S3203, S3206, or S3209, any such light beam is excluded.

### Step S3211

The control circuit 130 selects, from the light beams selected in step S3210, one light beam that needs the smallest amount of adjustment about the high-speed axis from the first light emission direction of the light source 110b. The emission direction of the selected light beam is set as a second light emission direction of the light source 110b.

Thus, via the process described above, the emission directions of the respective four light beam that are to be consecutively emitted in one unit period and the order of emitting them are determined.

In the present embodiment, the light source 110a and the light source 110b each consecutively emit light beams in two directions, but each light source may emit three or more light beams consecutively. Also in this case, the combination of the emission directions of the light beams may be selected in a similar manner as described above. An example is described below for a case in which each light source emits three or more light beams in each unit period.

FIG. 31B is a flowchart showing an example of a method for determining light beams for a case where each light source emits three or more light beams consecutively in different directions. Here, let n denote the number of light beams emitted consecutively by each light source where n is an integer equal to or larger than 3. The control circuit 130 executes a process including steps S3221 to S3232 shown in FIG. 31B. Each step of the operation is described below.

### Step S3221

The control circuit 130 determines whether or not n light beams to be emitted consecutively from each of the light sources 110a and 110b are all selected. In a case where all light beams have already been selected, the process proceed to step S1300. In a case where there is a light beam which has not yet been selected, the process proceed to step S3222.

### Step S3222

The control circuit 130 determines whether or not one or more light beams to be emitted by the light source 110a have already been selected out of the n light beams to be selected. In a case where no light beam has been selected yet, the process proceed to step S3225. In a case where one or more light beams have already been selected, the process proceeds to step S3223.

### Step S3223

For each of the light sources 110a and 110b, the control circuit 130 sets an immediately previously determined light emission direction of a light beam as a reference direction in the adjustment. That is, when a k-th light beam (k is an integer equal to or larger than 2) is selected from the n light beams, the light emission direction of a (k−1)th light beam is set as the reference direction.

### Step S3224

The control circuit 130 acquires information on the projection of light emission direction onto the light receiving surface for all light emission directions which have been already selected for each of the light sources 110a and 110b. That is, for each of the light sources 110a and 110b, the control circuit 130 acquires, from the memory 131, information on straight lines obtained when the directions of the first to (k−1)th light beams are respectively projected onto the light receiving surface of the image sensor 121.

### Step S3225

The control circuit 130 selects all light beams which need the smallest amount of adjustment about the low-speed axis from light beams which are stored in the memory 131 and which are to be emitted from the light source 110a but which have not yet been selected. However, when a direction of a light beam is projected onto the light receiving surface of the image sensor 121, if the resultant projected line overlaps or intersects the straight line obtained in step S3224, any such light beam is excluded. Here, the amount of adjustment about the low-speed axis is determined with reference to the direction of the light beam immediately previously selected for the light source 110a or with reference to the direction of the light beam specified in the initial setting. When a second or subsequent light beam is selected, the direction of the light beam set in step S3223 as the reference direction is used as the reference direction in the selection.

### Step S3226

The control circuit 130 selects one light beam that needs the smallest amount of adjustment about the high-speed axis from the light beams selected in step S3225. The amount of adjustment about the high-speed axis is also determined with reference to the direction of the light beam immediately previously selected for the light source 110a or with reference to the direction of the light beam specified in the initial setting.

### Step S3227

The control circuit 130 calculates a straight line obtained when the direction of the light beam selected in step S3226 is projected onto the light receiving surface of the image sensor 121, and stores the information on the calculation result in the memory 131.

### Step S3228

The control circuit 130 determines whether or not one or more light beams to be emitted by the light source 110b have already been selected out of the n light beams to be selected. In a case where no light beam has been selected yet, the process proceed to step S3230. In a case where one or more light beams have already been selected, the process proceeds to step S3229.

### Step S3229

The control circuit 130 acquires information on the projection of light emission direction onto the light receiving surface for all light emission directions which have been already selected for each of the light sources 110a and 110b. Note that this information also includes the information calculated in step S3227.

### Step S3230

The control circuit 130 selects all light beams which need the smallest amount of adjustment about the low-speed axis from light beams which are stored in the memory 131 and which are to be emitted from the light source 110b but which have not yet been selected. However, when a direction of a light beam is projected onto the light receiving surface of the image sensor 121, if the resultant projected line overlaps or intersects the straight line obtained in step S3229, any such light beam is excluded. Here, the amount of adjustment about the low-speed axis is determined with reference to the direction of the light beam immediately previously selected for the light source 110b or with reference to the direction of the light beam specified in the initial setting. When a second or subsequent light beam is selected, the direction of the light beam set in step S3223 as the reference direction is used as the reference direction in the selection.

### Step S3231

The control circuit 130 selects one light beam that needs the smallest amount of adjustment about the high-speed axis from the light beams selected in step S3230. The amount of adjustment about the high-speed axis is also determined with reference to the direction of the light beam immediately previously emitted from the light source 110b or the direction of the light beam specified in the initial setting.

### Step S3232

The control circuit 130 calculates a straight line obtained when the direction of the light beam selected in step S3231 is projected onto the light receiving surface of the image sensor 121, and stores the information on the calculation result in the memory 131.

By repeatedly performing the process described above, the control circuit 130 can sequentially select n light beams to be consecutively emitted from each of the light sources 110a and 110b.

In this example, two light sources are provided, but three or more light sources may be used. Also in the case where the distance measurement is performed by emitting a plurality of light beams simultaneously or sequentially from three or more light sources, a combination of light beams and an order of emitting them may be determined in a similar manner as described above. Also in the case where three or more light sources are used, the combination of light beams is determined such that when paths of light beams emitted in the same unit period are projected onto the light receiving surface, resultant projected lines do not overlap and do not intersect with each other. Furthermore, the order of emitting the light beams from each light source is determined so as to minimize the time required to adjust the light emission directions of each light source. In a case where the light emission direction of each light source is adjusted about both the low-speed axis and the high-speed axis, the order of emitting light beams is determined with higher priority given to reducing the amount of adjustment about the low-speed axis.

In the examples shown in FIGS. 31A and 31B, the selection of the light beams and the determination of the order of emitting them are performed at the same time. However, they may be performed separately. For example, directions of a plurality of light beams to be consecutively emitted may be selected first, and then the order of emitting the selected plurality of light emission directions may be determined. An example of such a process is described below with reference to FIGS. 31C to 31D.

FIG. 31C is a flowchart illustrating another example of a process in step S1200 for a case where a plurality of light beams are consecutively emitted in different directions from a plurality of light sources at the same time. Here, m denotes the number of light sources, and n denotes the number of light beams emitted consecutively from each light source, where m and n are each an integer equal to or larger than 2. In this example, the control circuit 130 executes a process including steps S3260 and S3270 described below.

### Step S3260

The control circuit 130 selects directions of n light beams for each of the m light sources. A specific example of a selection method is described later.

### Step S1270

The control circuit 130 determines, for each light source, the light emission order of 1st to nth light beams of the n light beams whose directions have been selected in step S3260 for each light source. This determination method is the same as in step S1270 in FIG. 21C. In step S3260, the combination of directions of a plurality of light beams is determined such that when the emission directions are projected on the image sensor plane, the resultant projected lines do not overlap and do not intersect with each other. Therefore, there is no need to consider the order of emitting light beams between the light sources. The order of emitting the light beams from each light source may be determined so as to minimize the amount of adjustment of light emission directions independently for each light source.

FIG. 31D is a flowchart illustrating in detail an operation of selecting directions of a plurality of light beams for respective light sources in step S3260. The control circuit 130 executes a process including steps S3261 to S3264 described below.

### Step S3261

The control circuit 130 calculates a straight line obtained when a direction of a light beam is projected onto light receiving surface of the image sensor, for each of all emission directions of light beams which are not emitted yet. Alternatively, in a case where the straight lines are pre-calculated and stored, the information about them is acquired.

### Step S3262

The control circuit 130 clusters, for each light source, all not-yet-emitted light beams into clusters each including n light beams according to criteria described below. The n light beams included in each cluster should satisfy the condition that when the emission directions of the n light beams are projected onto the light receiving surface of the image sensor 121, the resultant projected lines do not overlap and do not intersect with each other in the light receiving surface. The n light beams included in each cluster also should satisfy the condition that the emission directions thereof are close to each other, that is, a small amount of adjustment is needed to change the emission direction from one light beam to another in the cluster. In a case where the light source used is realized by a beam scanner having a low-speed axis and a high-speed axis for adjusting the beam emission direction, weighting may be performed according to the adjustment speed for each axis in the calculation of the amount of adjustment. In the case where the light source adjusts the light emission direction about two rotation axes as with a MEMS mirror, the amount of adjustment is given by the sum of the rotation angles about each rotation axis. In a case where the rotation speed differs greatly depending on the rotation axis as with the MEMS mirror, the angle about the low-speed axis is weighted by a factor of, for example, 5 with respect to the angle about the high-speed angle in the calculation of the adjustment amount. The control circuit 130 performs clustering according to the adjustment amount such that the total adjustment amount between the light emission directions is small.

### Step S3263

The control circuit 130 generates a combination of clusters by selecting one cluster for each light source from the clusters generated in step S3262 for each light source. From combinations of clusters, one or more combinations of clusters are selected such that the calculated projected lines obtained in step S3261 do not intersect on the light receiving surface of the image sensor 121 for all light emission directions included in the clusters for each light source.

### Step S3264

The control circuit 130 selects, from the one or more combinations of clusters of the respective light sources selected in step S3263, a combination of clusters that results in a smallest sum of adjustment amounts of the respective clusters.

In the example shown in FIG. 31D, clustering of the light emission directions is performed for each light source for each unit period via the process of steps S3261 and S3262. However, clustering may be performed in different manners. For example, a plurality of clusters may be generated in advance and stored, for example, such that a cluster identification code is assigned to a combination of a light source and light emission directions. Such information about clusters may be stored in advance in the memory 131.

### 2-2-2 Charge Measurement by Light Emission and Exposure Operation

Next, the details of the process including the light emission process performed by the light sources 110a and 110b and the exposure operation performed by the light receiving device 120 according to the present embodiment are described below.

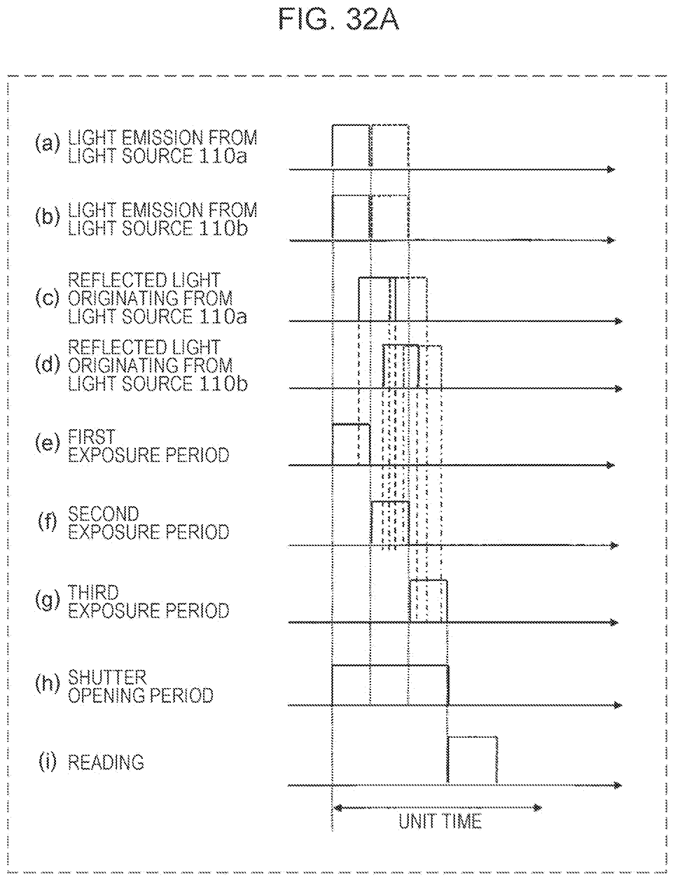

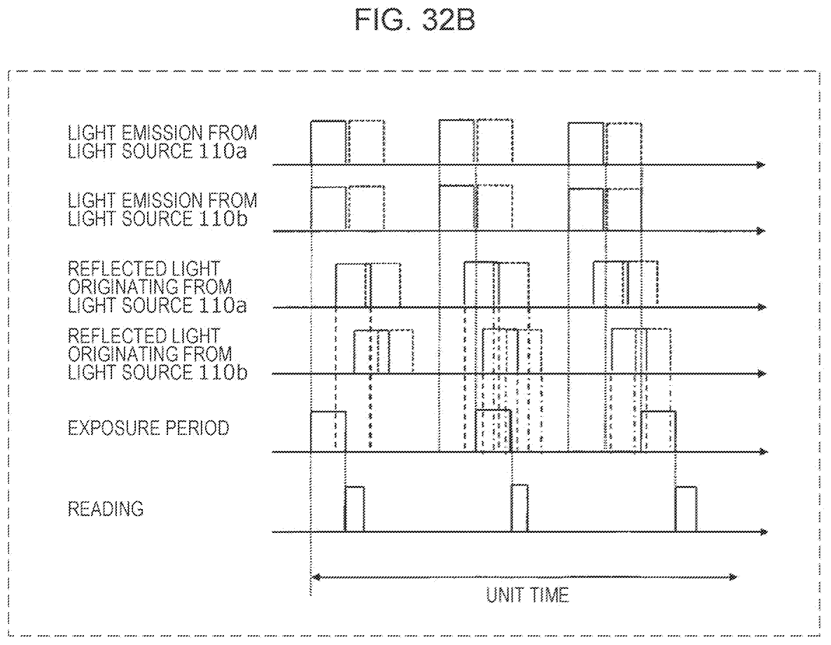

FIG. 32A is a diagram illustrating a first example of a light detection process for a case where two light beams are consecutively emitted in different directions from each of the light sources 110a and 110b in each unit period. A horizontal axis represents time. In this example, an exposure operation is performed consecutively three times in a unit period.

FIG. 32A(a) shows timings at which two light beams are emitted from the light source 110a. FIG. 32A(b) shows timings at which two light beams are emitted from the light source 110b. FIG. 32A(c) shows timings at which two pieces of reflected light originating from two light beams emitted from the light source 110a reach the image sensor 121. FIG. 32A(d) shows timings at which two pieces of reflected light originating from two light beams emitted from the light source 110b reach the image sensor 121. FIGS. 32A(c), 32A(d), and 32A(e) respectively show first to third exposure periods. FIG. 32A(h) shows a shutter opening period of the image sensor 121. FIG. 32A(g) shows a period in which a charge accumulated in each light receiving element is read out.

In this example, the image sensor 121 includes three charge accumulation units for each pixel. In each unit period, by switching the charge accumulation units that store charges, it is possible to detect reflected light in each of three exposure periods without performing reading. The process is similar to that shown in FIG. 7A except that the plurality of light sources 110a and 110b emit light simultaneously.

In the example shown in FIG. 32A, in one unit period, two light beams are emitted simultaneously in different directions, and then consecutively two light beams are emitted in two directions different from any of the previous two directions. That is, four light beams in different directions are each emitted once, and four pieces of reflected light from the four directions are received by four light receiving elements or light receiving element groups on the light receiving surface of the image sensor 121. Each light receiving element accumulates a charge generated as a result of receiving light in the exposure period. As a result of switching the charge accumulation units, charges are accumulated in the three different charge accumulation units respectively in the first to third exposure periods. When the third exposure period ends, signals indicating the amount of charges are read out from all charge accumulation units. The read signals are sent, as light reception data, to the signal processing circuit 140. Based on the light reception data, the signal processing circuit 140 can calculate the distance for the light receiving element that has received the reflected light by the method described above with reference to FIG. 6A.

In the example shown in FIG. 32A, although a plurality of charge accumulation units are required for each light receiving element, charges stored in the plurality of charge accumulation units can be output at once. This makes it possible to repeat the light emission and the exposure operation in a shorter time.

FIG. 32B is a diagram illustrating a second example of a light detection process for a case where two light beams are consecutively emitted in different directions from each of the light sources 110a and 110b in each unit period. In this example, each light receiving element does not need to have a plurality of charge accumulation units. The process shown in FIG. 32B is similar to that shown in FIG. 7B except that the plurality of light sources 110a and 110b are provided and they emit light at the same time.

In the example shown in FIG. 32B, a charge output process is performed each time an exposure period ends. A sequence of operations is performed three times in one unit period, wherein the sequence of operation includes an operation of emitting two light beams from each of the light sources 110a and 110b, an exposure operation, and a charge output operation is executed three times. Thus, as in the example shown in FIG. 32A, it is possible to acquire light reception data according to the amount of charge in each exposure period for each light receiving element. As a result, the distance can be calculated by performing the above-described calculation.

In the example shown in FIG. 32B, each light receiving element needs to have only one charge accumulation unit, which makes it possible to simplify the structure of the image sensor.

In the examples shown in FIGS. 32A and 32B, each unit period includes three exposure periods, but the number of exposure periods per unit period may be equal to or smaller than 2 or equal to or larger than 4. The timings of light emission and light reception may be adjusted depending on the setting of the reach range of a plurality of light beams.

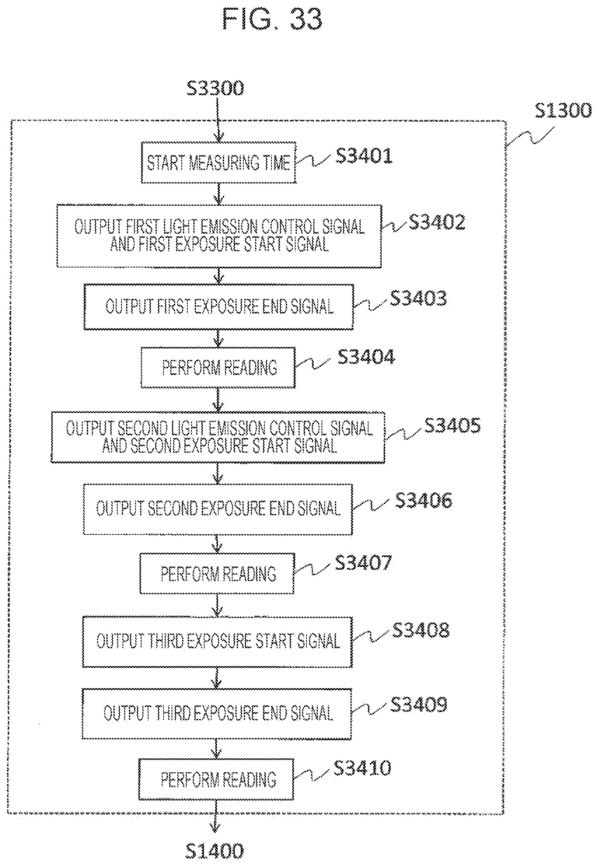

FIG. 33 is a flowchart showing a light emission operation and an exposure operation according to the present embodiment. This flowchart shows details of the operation of step S1300 shown in FIG. 19. Here, the process is described by way of example for a case where the control is performed as shown in FIG. 32B. The control circuit 130 according to the present embodiment executes a process including steps S3401 to S3408 shown in FIG. 33. Each step of the operation is described below.

### Step S3401

The control circuit 130 starts measuring time.

### Step S3402

The control circuit 130 outputs first light emission control signals to the respective light sources 110a and 110b and a first exposure start signal to the light receiving device 120. In response to the first light emission control signals, the light sources 110a and 110b outputs their first light beams. At the same time, in response to the first exposure start signal, the light receiving device 120 starts a charge accumulation operation.

### Step S3403

When a preset time length of the exposure period elapses, the control circuit 130 outputs a first exposure end signal to the light receiving device 120. In response to the first exposure end signal, the light receiving device 120 ends the charge accumulation operation.

### Step S3404

The control circuit 130 controls the light receiving device 120 to read the charge accumulated in the first exposure period. The light receiving device 120 sends light reception data according to the amount of charge accumulated in the charge accumulation unit to the signal processing circuit 140.

### Step S3405

The control circuit 130 outputs second light emission control signals to the respective light sources 110a and 110b and a second exposure start signal to the light receiving device 120. In response to the second light emission control signals, the light sources 110a and 110b outputs their second light beams. At the same time, in response to the second exposure start signal, the light receiving device 120 starts a charge accumulation operation.

### Step S3406

When a preset time length of the exposure period elapses, the control circuit 130 outputs a second exposure end signal to the light receiving device 120. In response to the second exposure end signal, the light receiving device 120 ends the charge accumulation operation.

### Step S3407

The control circuit 130 controls the light receiving device 120 to read the charge accumulated in the second exposure period. The light receiving device 120 sends light reception data according to the amount of charge accumulated in the charge accumulation unit to the signal processing circuit 140.

### Step S3408

The control circuit 130 outputs a third exposure start signal to the light receiving device 120. In response to the third exposure start signal, the light receiving device 120 starts a charge accumulation operation.

### Step S3409

When a preset time length of the exposure period elapses, the control circuit 130 outputs a third exposure end signal to the light receiving device 120. In response to the third exposure end signal, the light receiving device 120 ends the charge accumulation operation.

### Step S3410

The control circuit 130 controls the light receiving device 120 to read the charge accumulated in the third exposure period. The light receiving device 120 sends light reception data according to the amount of charge accumulated in the charge accumulation unit to the signal processing circuit 140.

### 2-3 Effects

As described above, the distance measurement apparatus 100A according to the second embodiment includes a plurality of light sources. A plurality of light beams emitted from the plurality of light sources include two or more light beams emitted simultaneously. More specifically, the plurality of light beams include a first light beam group emitted simultaneously at the first timing and a second light beam group emitted simultaneously at the second timing different from the first timing. The control circuit 130 performs control such that in a plurality of consecutive exposure periods included in each unit period, each of a plurality of light receiving elements performs an exposure operation thereby causing part of the plurality of light receiving elements to receive reflected light in the same exposure period, and outputs light reception data according to the amount of received light is output. Also in the present embodiment, the control circuit 130 determines the combination of the directions of the plurality of light beams such that the paths of the plurality of light beams projected onto the light receiving surface of the light receiving device 120 do not overlap or intersect with each other on the light receiving surface.

Thus, the distance can be measured for the entire scene in a short time as compared with the conventional distance measuring system in which a light beam is emitted in only one direction in each unit period. Therefore, even when the distance measurement is performed for a large target area, the distance measurement can be performed in a practically short time. Furthermore, it is possible to prevent a plurality of pieces of reflected light from a plurality of objects existing at different positions from being incident on the same light receiving element, which makes it possible to achieve higher accuracy in the distance measurement.

In the second embodiment, a plurality of light sources emit light beams simultaneously. However, the plurality of light sources may emit light beams at different timings. Also in this case, the above-described effects can be obtained.

### Modification of Second Embodiment

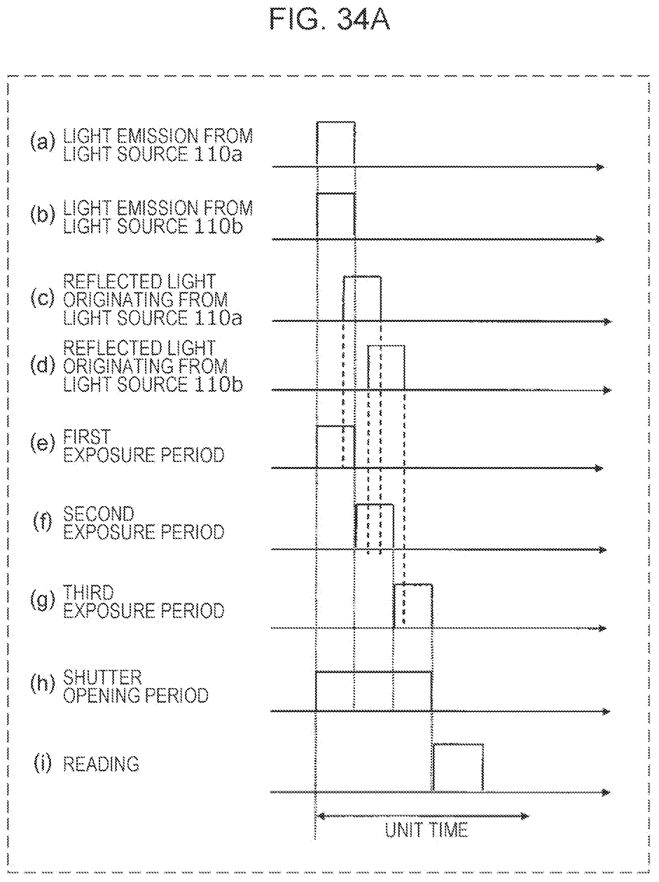

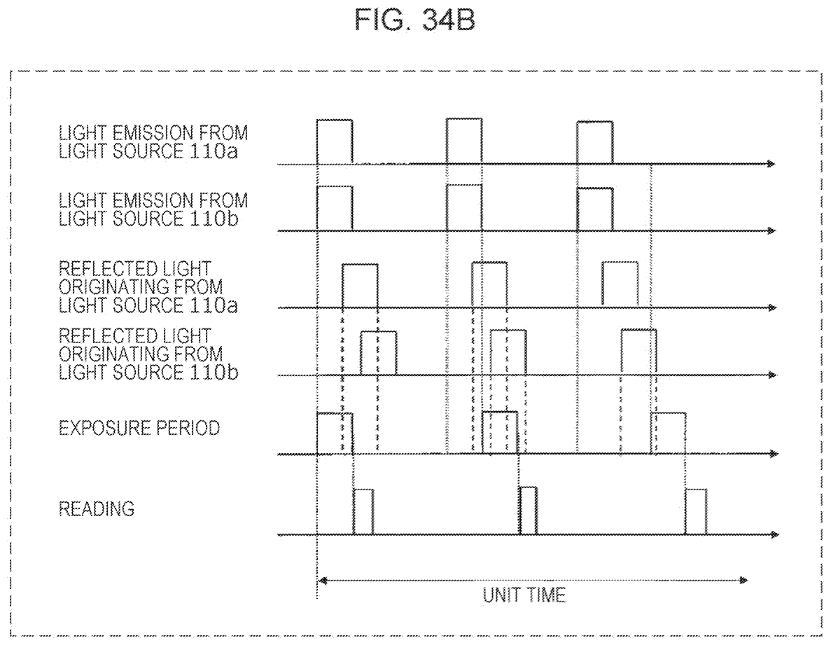

In the example shown in FIG. 32A, two light beams are consecutively emitted in different directions at different timings from each of the light sources 110a and 110b. A modification thereof is shown in FIG. 34A.

In the example shown in FIG. 34A, two light beams are simultaneously emitted in different directions from the light sources 110a and 110b in one unit period. That is, two light beams are emitted simultaneously in different directions, and two pieces of reflected light from two directions are received by two light receiving elements or light receiving element groups on the light receiving surface of the image sensor 121. Each light receiving element accumulates a charge generated as a result of receiving light in the exposure period. As a result of switching the charge accumulation units, charges are accumulated in the three different charge accumulation units respectively in the first to third exposure periods. When the third exposure period ends, signals indicating the amount of charges are read out from all charge accumulation units. The read signals are sent, as light reception data, to the signal processing circuit 140. The signal processing circuit 140 can calculate the distance for the light receiving element that has received the reflected light based on the light reception data.

Also in this modification, the distance can be measured for the entire scene in a short time as compared with the conventional distance measurement system in which a light beam is emitted in only one direction in each unit period.

Note that the light sources 110a and 110b may be replaced with a single light source capable of emitting a plurality of light beams in different directions at the same time.

### Second Modification of Second Embodiment

FIG. 34B is a diagram illustrating a second modification of the second embodiment. In this example, each light receiving element does not need to have a plurality of charge accumulation units.

In the example shown in FIG. 34B, a charge output process is performed each time an exposure period ends. In one unit period, a sequence of operations is performed three times wherein the sequence operations includes an operation of emitting two light beams from each of the light sources 110a and 110b, an exposure operation, and a charge output operation. Thus, as in the example shown in FIG. 32B, it is possible to acquire light reception data according to the amount of charge in each exposure period for each light receiving element. As a result, the distance can be calculated by performing the above-described calculation.

In the example shown in FIG. 34B, each light receiving element needs to have only one charge accumulation unit, which makes it possible to simplify the structure of the image sensor.

Note that also in this modification, the light sources 110a and 110b may be replaced with a single light source capable of emitting a plurality of light beams in different directions at the same time.

In each of the above-described embodiments, the determination in step S1200 in FIG. 19 as to the combination of plurality of light beams emitted in each unit period and as to the order of emitting them may not be performed each the operation is performed. After the determination is performed once at the beginning, light beams may be emitted in the same manner according to the determination performed at the beginning.

The technique disclosed here can be widely used in distance measurement apparatuses using a laser beam. For example, the technique disclosed here is useful for LiDAR.

What is claimed is:

1. A distance measurement apparatus comprising:
at least one light source that emits a light beam towards a scene;
a light receiving device that includes a plurality of light receiving elements and that receives reflected light from the scene generated by irradiation of the light beam;
a control circuit that performs a control operation on the at least one light source and the light receiving device, the control operation including
causing at least one exposure operation and a charge output operation to be repeatedly executed such that in the at least one exposure operation, at least part of the plurality of light receiving elements detect a charge generated by received reflected light, and accumulate the generated charge, while in the charge output operation, the accumulated charge is read out,
determining a combination of directions of the plurality of light beams such that a plurality of pieces of reflected light generated by irradiation of the plurality of light beams are respectively incident on different light receiving elements of the plurality of light receiving elements, and
causing the at least one light source to emit the plurality of light beams toward the scene between consecutive two charge output operations; and
a signal processing circuit that generates distance data based on light reception data generated based on the charge and outputs the resultant distance data.

2. The distance measurement apparatus according to claim 1, wherein
the plurality of light receiving elements are two-dimensionally arranged along a light receiving surface of the light receiving device, and
the control circuit determines the combination of directions of the plurality of light beams such that paths of the plurality of light beams projected onto the light receiving surface do not overlap and do not intersect with each other on the light receiving surface.

3. The distance measurement apparatus according to claim 1, wherein the plurality of light beams include a first light beam emitted at a first timing and a second light beam emitted at a second timing different from the first timing.

4. The distance measurement apparatus according to claim 1, wherein the plurality of light beams include two or more light beams emitted simultaneously.

5. The distance measurement apparatus according to claim 1, wherein the plurality of light beams include a first light beam group emitted simultaneously at a first timing and a second light beam group emitted simultaneously at a second timing different from the first timing.

6. The distance measurement apparatus according to claim 1, wherein
the at least one light source is a single light source, and
the control circuit controls the light source to emit the plurality of light beams sequentially.

7. The distance measurement apparatus according to claim 1, wherein
the at least one light source includes a plurality of light sources, and
the control circuit controls the plurality of light sources to emit at least part of the plurality of light beams simultaneously.

8. The distance measurement apparatus according to claim 1, wherein
in each of a plurality of unit periods each including at least the one charge output operation, the control circuit causes
the at least one light source to emit the plurality of light beams, and
at least part of the plurality of light receiving elements to receive the reflected light from the scene generated as a result of irradiation of the plurality of light beams,
wherein the combination of directions of the plurality of light beams differs for each unit period.

9. The distance measurement apparatus according to claim 8, wherein the plurality of light beams emitted in the plurality of unit periods cover, as a whole, the whole distance measurement target area.

10. The distance measurement apparatus according to claim 9, wherein the signal processing circuit generates distance image data of the distance measurement target area after the emission and reception of the plurality of light beams in the plurality of unit periods are completed.

11. The distance measurement apparatus according to claim 1, wherein the control circuit performs control such that at least part of the plurality of light receiving elements detect, in a same exposure period, the reflected light generated by the plurality of light beams.

12. The distance measurement apparatus according to claim 1, wherein the plurality of light receiving elements include a global shutter type electronic shutter.

13. A non-transitory computer-readable storage medium storing a program that causes a computer to execute
causing at least part of a plurality of light receiving elements to repeatedly execute at least one exposure operation and a charge output operation such that in the at least one exposure operation, light from a scene is received and a charge generated as a result of receiving the light is detected and accumulated, while in the charge output operation, the accumulated charge is output;
determining a combination of directions of the plurality of light beams such that a plurality of pieces of reflected light generated by irradiation of the plurality of light beams are respectively incident on different light receiving elements of the plurality of light receiving elements;
causing at least one light source to emit the plurality of light beams toward the scene between consecutive two charge output operations; and
generating distance data based on light reception data generated based on the charge, and outputting the resultant distance data.

14. A method of measuring a distance, comprising:
causing at least part of a plurality of light receiving elements to repeatedly execute at least one exposure operation and a charge output operation such that in the at least one exposure operation, light from a scene is received and a charge generated as a result of receiving the light is detected and accumulated, while in the charge output operation, the accumulated charge is output;
determining a combination of directions of the plurality of light beams such that a plurality of pieces of reflected light generated by irradiation of the plurality of light beams are respectively incident on different light receiving elements of the plurality of light receiving elements;
causing at least one light source to emit the plurality of light beams toward the scene between consecutive two charge output operations; and
generating distance data based on light reception data generated based on the charge, and outputting the resultant distance data.

15. A distance measurement apparatus comprising:
at least one light source that emits a light beam towards a scene;
a light receiving device that includes a plurality of light receiving elements and that receives reflected light from the scene generated by irradiation of the light beam;
a control circuit that performs a control operation on the at least one light source and the light receiving device, the control operation including
causing at least part of the plurality of light receiving elements to perform at least one exposure operation in which the reflected light is received and a charge generated as a result of receiving the reflected light is detected,
determining a combination of directions of the plurality of light beams such that a plurality of pieces of reflected light generated by irradiation of the plurality of light beams are respectively incident on different light receiving elements of the plurality of light receiving elements, and
causing at least one light source to emit the plurality of light beams toward the scene in one exposure period; and
a signal processing circuit that generates distance data based on light reception data generated based on the charge and outputs the resultant distance data.

16. The distance measurement apparatus according to claim 15, wherein
the plurality of light receiving elements are two-dimensionally arranged along a light receiving surface of the light receiving device, and
the control circuit determines the combination of directions of the plurality of light beams such that paths of the plurality of light beams projected onto the light receiving surface do not overlap and do not intersect with each other on the light receiving surface.

17. The distance measurement apparatus according to claim 15, wherein the plurality of light beams include a first light beam emitted at a first timing and a second light beam emitted at a second timing different from the first timing.

18. The distance measurement apparatus according to claim 15, wherein the plurality of light beams include a first light beam group emitted simultaneously at a first timing and a second light beam group emitted simultaneously at a second timing different from the first timing.

19. The distance measurement apparatus according to claim 15, wherein
the at least one light source is a single light source, and
the control circuit controls the light source to emit the plurality of light beams sequentially.

20. The distance measurement apparatus according to claim 15, wherein
in each of a plurality of unit periods each including at least one exposure operation, the control circuit causes
the at least one light source to emit the plurality of light beams, and
at least part of the plurality of light receiving elements to receive the reflected light from the scene generated as a result of irradiation of the plurality of light beams,
wherein the combination of directions of the plurality of light beams differs for each unit period.

21. The distance measurement apparatus according to claim 15, wherein the plurality of light receiving elements include a global shutter type electronic shutter

22. A non-transitory computer-readable storage medium storing a program that causes a computer to execute
causing at least part of a plurality of light receiving elements to execute at least one exposure operation in which reflected light is received and a charge generated as a result of receiving the reflected light is detected;
determining a combination of directions of a plurality of light beams such that a plurality of pieces of reflected light generated by irradiation of the plurality of light beams are respectively incident on different light receiving elements of the plurality of light receiving elements;
causing at least one light source to emit the plurality of light beams toward a scene in the one exposure operation; and
generating distance data based on light reception data generated based on the charge, and outputting the resultant distance data.

23. A method of measuring a distance, comprising:
causing at least part of a plurality of light receiving elements to execute at least one exposure operation in which reflected light is received and a charge generated as a result of receiving the reflected light is detected;
determining a combination of directions of a plurality of light beams such that a plurality of pieces of reflected light generated by irradiation of the plurality of light beams are respectively incident on different light receiving elements of the plurality of light receiving elements;
causing at least one light source to emit the plurality of light beams toward a scene in the one exposure operation; and
generating distance data based on light reception data generated based on the charge, and outputting the resultant distance data.
